(19) United States
(12) Patent Application Publication
(10) Pub. No.: US 2015/0169260 A1
(43) Pub. Date: Jun. 18, 2015

(54) ENHANCED PRINTER FUNCTIONALITY WITH DYNAMIC IDENTIFIER CODE

(71) Applicant: ZIH Corp., Lincolnshire, IL (US)

(72) Inventors: Robert M. McLeod, Chicago, IL (US); Cabel J. M. Sholdt, Vernon Hills, IL (US); Michael S. Millman, Camas, WA (US); Martin A. K. Schwan, Chicago, IL (US); James P. Van Huis, Des Plaines, IL (US)

(21) Appl. No.: 14/631,052

(22) Filed: Feb. 25, 2015

Related U.S. Application Data
(63) Continuation of application No. 13/729,552, filed on Dec. 28, 2012.
(60) Provisional application No. 61/581,755, filed on Dec. 30, 2011.

(51) Int. Cl. G06F 3/12; G06K 7/10

(52) U.S. Cl. CPC G06F 3/1204; G06F 3/1297; G06F 3/1205; G06F 3/1254; G06F 3/1294; G06K 7/1092

(57) ABSTRACT

An apparatus may comprise a code output device and a processor configured to detect a first apparatus condition indication, generate a first dynamic identifier code representative of a first apparatus condition in response to detecting the first apparatus condition indication, output the first dynamic identifier code to the code output device, detect a second apparatus condition indication, generate a second dynamic identifier code representative of a second apparatus condition in response to detecting the second apparatus condition indication, wherein the second dynamic identifier code is different than the first dynamic identifier code, and output the second dynamic identifier code to the code output device. Associated methods, computer program products, and systems are also provided.

### CROSS-REFERENCE TO RELATED APPLICATIONS

This application is a continuation of U.S. application Ser. No. 13/729,559 filed Dec. 28, 2012 which claims priority to U.S. Provisional Application No. 61/581,755, filed Dec. 30, 2011, the entire contents of each is incorporated by reference herein in its entirety.

### BACKGROUND OF THE INVENTION

Various embodiments of the invention are directed to printers and other systems for processing media including labels, receipt media, cards, and the like. Applicant has identified a number of deficiencies and problems associated with the setup, use, and maintenance of conventional printers. Through applied effort, ingenuity, and innovation, Applicant has solved many of these identified problems by developing a solution that is embodied by the present invention, which is described in detail below.

### BRIEF SUMMARY

Various embodiments of the present invention are directed to a device and associated system for enhanced printer functionality and troubleshooting through the use of dynamic identifier codes, such as barcodes and/or quick response codes (“QR codes”). Example embodiments may provide a user interface of a printer system that may be configured to enhance user functionality, serviceability, and/or other user interactions. Such embodiments are configured to provide these advantages through the use of mobile computing devices configured to acquire image data, such as mobile phones, tablet computers, laptops, and other computing devices.

According to one embodiment, an apparatus comprises a code output device and a processor configured to detect a first apparatus condition indication, generate a first dynamic identifier code representative of a first apparatus condition in response to detecting the first apparatus condition indication, output the first dynamic identifier code to the code output device, detect a second apparatus condition indication, generate a second dynamic identifier code representative of a second apparatus condition in response to detecting the second apparatus condition indication, wherein the second dynamic identifier code is different than the first dynamic identifier code, and output the second dynamic identifier code to the code output device.

According to another embodiment, an apparatus comprises a code acquisition module configured to capture a first image associated with a first dynamic identifier code representative of a first apparatus condition and a second image associated with a second dynamic identifier code representative of a second apparatus condition, wherein the second dynamic identifier code is different than the first dynamic identifier code. The apparatus may further comprise a communications module configured to communicate with at least one of a server and a printer, a display, and a processor. The processor may be configured to receive a first user message associated with the first apparatus condition, output the first user message to the display, receive a second user message associated with the second apparatus condition, and output the second user message to the display.

According to another embodiment, an apparatus may comprise a code acquisition module configured to capture a first image associated with a first dynamic identifier code representative of a first apparatus condition and a second image associated with a second dynamic identifier code representative of a second apparatus condition, wherein the second dynamic identifier code is different than the first dynamic identifier code. The apparatus may further include a memory storing a first user message associated with the first apparatus condition, a second user message associated with the second apparatus condition, and a user identity data. The apparatus may include a display, and a processor configured to extract first apparatus condition data from the first image associated with the first dynamic identifier code, retrieve the first user message from memory in response to extracting the first apparatus condition data, output the first user message to the display, extract second apparatus condition data from the second image associated with the second dynamic identifier code, retrieve the second user message from memory in response to extracting the second apparatus condition data, and output the second user message to the display.

In one embodiment, an apparatus may comprise a communications module configured to communicate with at least one of a code reading device and a printer device, and a memory storing at least one user identity associated with the code reading device, a first user message associated with a first apparatus condition, and a second user message associated with a second apparatus condition, wherein the first apparatus condition corresponds with a first dynamic identifier code, and the second apparatus condition correspond with a second dynamic identifier code, and wherein the second dynamic identifier code is different than the first dynamic identifier code. The apparatus may further include a processor configured to receive a first image data corresponding to the first image associated with the first dynamic identifier code representative of the first apparatus condition, extract first apparatus condition data from the first image data corresponding to the first image associated with the first dynamic identifier code representative of the first apparatus condition, retrieve the first user message from memory in response to extracting the first apparatus condition data, cause the first user message to be transmitted, receive a second image data corresponding to the second image associated with the second dynamic identifier code representative of the second apparatus condition, extract second apparatus condition data from the second image data corresponding to the second image associated with the second dynamic identifier code representative of the second apparatus condition, retrieve the second user message from memory in response to extracting the second apparatus condition data, and cause the second user message to be transmitted.

According to one embodiment, an apparatus may include a communications module configured to communicate with at least one of a code reading device and a printer device, and a memory storing at least one user identity associated with the code reading device, a first user message associated with a first apparatus condition, and a second user message associated with a second apparatus condition, wherein the first apparatus condition corresponds with a first dynamic identifier code, and the second apparatus condition correspond with a second dynamic identifier code, and wherein the second dynamic identifier code is different than the first dynamic identifier code. The apparatus may include an identifying code processor configured to extract first apparatus condition data from a first image data corresponding to a first image associated with the first dynamic identifier code representative of the first apparatus condition, retrieve the first user message from memory in response to extracting the first apparatus condition data, extract second apparatus condition data from a second image data corresponding to a second image associated with the second dynamic identifier code representative of the second apparatus condition, and retrieve the second user message from memory in response to extracting the second apparatus condition data. In addition, the apparatus may comprise a processor configured to receive the first image data corresponding to the first image associated with the first dynamic identifier code representative of the first apparatus condition, receive the second image data corresponding to the second image associated with the second dynamic identifier code representative of the second apparatus condition, cause the first user message to be transmitted, and cause the second user message to be transmitted.

According to some embodiments, a method is provided comprising detecting a first apparatus condition indication, generating a first dynamic identifier code representative of a first apparatus condition in response to detecting the first apparatus condition indication, providing the first dynamic identifier code to a code output device, detecting a second apparatus condition indication, generating a second dynamic identifier code representative of a second apparatus condition in response to detecting the second apparatus condition indication, wherein the second dynamic identifier code is different than the first dynamic identifier code, and providing the second dynamic identifier code to the code output device.

According to another embodiment, a method is provided comprising capturing a first image associated with a first dynamic identifier code representative of a first apparatus condition, causing a user identity data corresponding to the user identity to be transmitted to a server, causing a first image data corresponding to the first image to be transmitted to the server, receiving a first user message associated with the first apparatus condition, providing the first user message to a display, capturing a second image associated with a second dynamic identifier code representative of a second apparatus condition, wherein the second dynamic identifier code is different than the first dynamic identifier code, causing a second image data corresponding to the second image to be transmitted to the server, receiving a second user message associated with the second apparatus condition, and providing the second user message to a display.

According to some embodiments, a method is provided comprising capturing a first image associated with a first dynamic identifier code representative of a first apparatus condition, extracting a first apparatus condition data from the first image associated with the first dynamic identifier code, retrieving data associated with a first apparatus condition solution in response to extracting the first apparatus condition data, causing an apparatus with a first apparatus condition to resolve the first apparatus condition by at least causing the data associated with the first apparatus condition solution to be transmitted to the apparatus, capturing a second image associated with a second dynamic identifier code representative of a second apparatus condition, wherein the second dynamic identifier code is different than the first dynamic identifier code, extracting the second apparatus condition data from the second image associated with the second dynamic identifier code, and retrieving data associated with a second apparatus condition solution in response to extracting the second apparatus condition data.

According to another embodiment, a method is provided comprising receiving user identity data, receiving a first image data corresponding to the first image associated with the first dynamic identifier code representative of the first apparatus condition, extracting first apparatus condition data from the first image data corresponding to the first image associated with the first dynamic identifier code representative of the first apparatus condition, retrieving the first user message from memory in response to at least one of extracting the first apparatus condition data and receiving the user identity data, causing the first user message to be transmitted to a code reading device, receiving a second image data corresponding to the second image associated with the second dynamic identifier code representative of the second apparatus condition, extracting second apparatus condition data from the second image data corresponding to the second image associated with the second dynamic identifier code representative of the second apparatus condition, retrieving the second user message from memory in response to at least one of extracting the second apparatus condition data and receiving the user identity data, and causing the second user message to be transmitted.

Another embodiment may provide for a method comprising receiving a first image data corresponding to the first image associated with the first dynamic identifier code representative of the first apparatus condition, extracting first apparatus condition data from the first image data corresponding to the first image associated with the first dynamic identifier code representative of the first apparatus condition, retrieving the first user message from memory in response to at least one of extracting the first apparatus condition data, causing the first user message to be transmitted to a code reading device, receiving a second image data corresponding to the second image associated with the second dynamic identifier code representative of the second apparatus condition, extracting second apparatus condition data from the second image data corresponding to the second image associated with the second dynamic identifier code representative of the second apparatus condition, retrieving the second user message from memory in response to extracting the second apparatus condition data, and causing the second user message to be transmitted.

According to one embodiment, a computer program product is provided comprising at least one non-transitory computer-readable storage medium having computer-readable program instructions stored therein, the computer-readable program instructions comprising program instructions configured to cause an apparatus to perform a method comprising detecting a first apparatus condition indication, generating a first dynamic identifier code representative of a first apparatus condition in response to detecting the first apparatus condition indication, providing the first dynamic identifier code to a code output device, detecting a second apparatus condition indication, generating a second dynamic identifier code representative of a second apparatus condition in response to detecting the second apparatus condition indication, wherein the second dynamic identifier code is different than the first dynamic identifier code, and providing the second dynamic identifier code to the code output device.

According to some embodiments, a computer program product is provided comprising at least one non-transitory computer-readable storage medium having computer-readable program instructions stored therein, the computer-readable program instructions comprising program instructions configured to cause an apparatus to perform a method comprising capturing a first image associated with a first dynamic identifier code representative of a first apparatus condition, causing a user identity data corresponding to the user identity to be transmitted to a server, causing a first image data corresponding to the first image to be transmitted to the server, receiving a first user message associated with the first apparatus condition, providing the first user message to a display, capturing a second image associated with a second dynamic identifier code representative of a second apparatus condition, wherein the second dynamic identifier code is different than the first dynamic identifier code, causing a second image data corresponding to the second image to be transmitted to the server, receiving a second user message associated with the second apparatus condition, and providing the second user message to a display.

In another embodiment, a computer program product is provided comprising at least one non-transitory computer-readable storage medium having computer-readable program instructions stored therein, the computer-readable program instructions comprising program instructions configured to cause an apparatus to perform a method comprising capturing a first image associated with a first dynamic identifier code representative of a first apparatus condition, extracting the first apparatus condition data from the first image associated with the first dynamic identifier code, retrieving a first user message from a memory in response to at least one of extracting the first apparatus condition data and a user identity, providing the first user message to a display, capturing a second image associated with a second dynamic identifier code representative of a second apparatus condition, wherein the second dynamic identifier code is different than the first dynamic identifier code, extracting the second apparatus condition data from the second image associated with the second dynamic identifier code, retrieving a second user message from a memory in response to at least one of extracting the second apparatus condition data and the user identity, and providing the second user message to a display.

Another embodiment may provide a computer program product comprising at least one non-transitory computer-readable storage medium having computer-readable program instructions stored therein, the computer-readable program instructions comprising program instructions configured to cause an apparatus to perform a method comprising receiving user identity data, receiving a first image data corresponding to the first image associated with the first dynamic identifier code representative of the first apparatus condition, extracting first apparatus condition data from the first image data corresponding to the first image associated with the first dynamic identifier code representative of the first apparatus condition, retrieving the first user message from memory in response to at least one of extracting the first apparatus condition data and receiving the user identity data, causing the first user message to be transmitted to a code reading device, receiving a second image data corresponding to the second image associated with the second dynamic identifier code representative of the second apparatus condition, extracting second apparatus condition data from the second image data corresponding to the second image associated with the second dynamic identifier code representative of the second apparatus condition, retrieving the second user message from memory in response to at least one of extracting the second apparatus condition data and receiving the user identity data, and causing the second user message to be transmitted.

Another embodiment of the present invention may provide a system comprising an apparatus. The apparatus may include a code output device, a processor configured to detect a first apparatus condition indication, generate a first dynamic identifier code representative of a first apparatus condition in response to detecting the first apparatus condition indication, output the first dynamic identifier code to the code output device, detect a second apparatus condition indication, generate a second dynamic identifier code representative of a second apparatus condition in response to detecting the second apparatus condition indication, wherein the second dynamic identifier code is different than the first dynamic identifier code, and output the second dynamic identifier code to the code output device. The system may further include a code reading device comprising an image capture device configured to capture a first image associated with the first dynamic identifier code and a second image associated with the second dynamic identifier code, a memory storing a first user message associated with the first apparatus condition and a second user message associated with the second apparatus condition, a display, and a processor configured to extract first apparatus condition data from the first image associated with the first dynamic identifier code, retrieve the first user message from memory in response to extracting the first apparatus condition data, output the first user message to the display, extract second apparatus condition data from the second image associated with the second dynamic identifier code, retrieve the second user message from memory in response to extracting the second apparatus condition data, and output the second user message to the display.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates an example apparatus (e.g., a printer device) that is configured in accordance with embodiments of the invention;

FIG. 2 illustrates a sample dynamic quick response code according to one embodiment of the present invention;

FIG. 3A illustrates a system for providing enhanced printer functionality according to one embodiment of the present invention;

FIG. 3B illustrates a system for providing enhanced printer functionality according to another embodiment of the present invention;

FIG. 3C illustrates a system for providing enhanced printer functionality according to yet another embodiment of the present invention;

FIG. 3D illustrates a system for providing enhanced printer functionality according to still another embodiment of the present invention;

FIG. 4 illustrates a schematic view of an example apparatus (e.g., a printer device) that is configured to provide enhanced printer functionality according to one embodiment of the present invention;

FIG. 5 illustrates a schematic view of an example code reading device according to one embodiment of the present invention;

FIG. 6 illustrates a schematic view of an example server device that is configured to provide enhanced user functionality for printer devices according to one embodiment of the present invention;

FIG. 7A illustrates a flowchart detailing a method of providing enhanced printer functionality according to one embodiment of the present invention;

FIG. 7B illustrates a flowchart detailing an alternative method of providing enhanced printer functionality according to another embodiment of the present invention;

FIG. 7C illustrates a flowchart detailing yet another method of providing enhanced printer functionality according to another embodiment of the present invention;

FIG. 7D illustrates a flowchart detailing yet another method of providing enhanced printer functionality according to another embodiment of the present invention;

FIG. 7E illustrates a flowchart detailing yet another method of providing enhanced printer functionality according to another embodiment of the present invention;

FIG. 7F illustrates a flowchart detailing yet another method of providing enhanced printer functionality according to another embodiment of the present invention;

FIG. 8A illustrates a flowchart detailing yet another method for providing enhanced printer functionality according to one embodiment of the present invention;

FIG. 8B illustrates a flowchart detailing yet another method for providing enhanced printer functionality according to one embodiment of the present invention;

FIG. 9A illustrates a flowchart detailing yet another method for providing enhanced printer functionality according to one embodiment of the present invention;

FIG. 9B illustrates a flowchart detailing yet another method for providing enhanced printer functionality according to one embodiment of the present invention;

FIG. 10 illustrates a code reading device configured to provide enhanced printer functionality according to one embodiment of the present invention;

FIG. 11 illustrates a flowchart detailing another method for providing enhanced printer functionality according to one embodiment of the present invention; and

FIG. 12 illustrates a table listing possible printer conditions, identifier codes, and possible solutions provided by a code reading device and/or a computer database according to some embodiments of the present invention.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Various embodiments of the present invention are directed to an apparatus (e.g., a printer) that is configured to detect an apparatus condition (e.g., an error condition, status information, etc.) and communicate information concerning the apparatus condition by displaying or printing a machine readable dynamic identifier code. The dynamic identifier code may then be read by a code reading device (e.g., a camera enabled smartphone), which is configured to download data and instructions for resolving the apparatus condition and/or improving the functionality or performance of the apparatus.

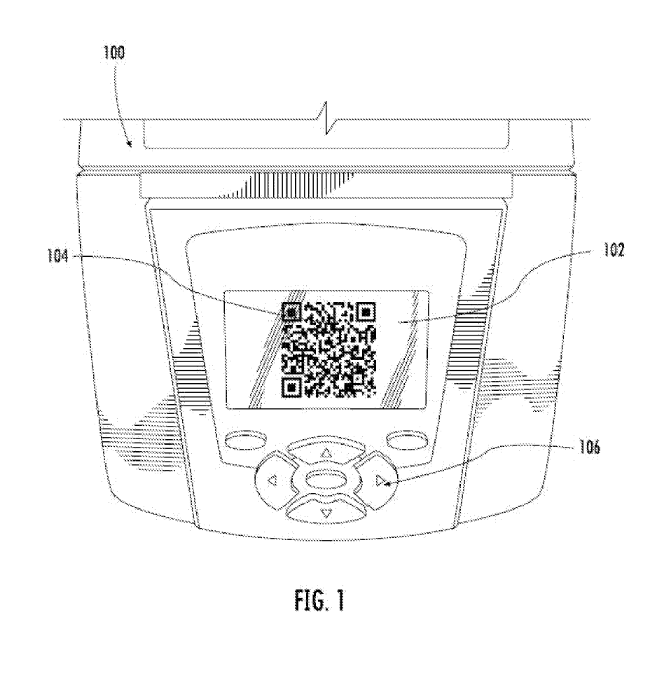

FIG. 1 depicts an example apparatus, i.e., printer device 100 structure in accordance with one embodiment of the invention. While the foregoing description refers specifically to a printer device for illustration purpose, one of ordinary skill in the art will appreciate that the inventive concepts herein described may be applied to any apparatus that is configured to detect and communicate apparatus conditions.

The depicted printer device 100 includes a graphical user interface 102 configured to provide and/or display a dynamic identifier code 104, such as a quick response code (“QR code”). Although the foregoing description refers to a QR code as an example dynamic identifier code, one of ordinary skill in the art will appreciate that the inventive concepts herein described may be applied to other dynamic identifier codes such as one-dimensional or linear bar code symbologies, two-dimensional bar code symbologies, three-dimensional barcode symbologies, or any other machine readable identifier code that is configurable for representing data associated with an apparatus condition.

Example two-dimensional barcodes, other than the depicted QR code, which are known in the art include EZcode, MaxiCode, Aztec Code, and the like. In some example embodiments, a QR code may include bar code symbology in accordance with an ISO (International Organization for Standardization) standard such as ISO/IEC 18004:2000 or ISO/IEC 18004:2006.

As described in greater detail herein, the depicted printer device 100 may be configured to display a dynamic identifier code (here a QR code) when the printer device 100 experiences an apparatus condition. The printer device may be configured to display a dynamic identifier code under any desired condition. For example, a dynamic identifier code may be generated and displayed by a printer device after the printer device experiences an error condition. Alternatively, the printer device may be configured to display the dynamic identifier code corresponding to the error condition only after the user has attempted to resolve the condition, but has been unsuccessful. In such an example, the user may prompt the printer device to display the dynamic identifier code after the user's error resolution attempts have failed. In other embodiments, a user prompt may not be needed as the dynamic identifier code is generated and displayed at a given time interval after the error condition is detected or perhaps after an unsuccessful attempt to resolve the error condition has been detected.

The term “dynamic” as used herein indicates that each identifier code is generated and displayed, in near real-time, in response to a particular apparatus condition or event. Said differently, the identifier code generated and displayed by a given printing device in response to a first condition that may be different (i.e., would embody new or added data, etc.) than the identifier code generated in response to a second condition, which is different than the first condition. The identifier code is dynamic or changing in response to apparatus conditions or events rather than fixed or static regardless of apparatus conditions or events.

For example, the depicted printer device 100 may be configured to display a first QR code when the printer device 100 experiences a printer media supply jam. The same printer device 100 may be further configured to generate and display a second QR code when the printer device 100 experiences a different condition, such as the printer device having depleted a supply of printer media. In addition, the same printer device may generate a third QR code when the printer device experiences a ribbon out condition.

In still other embodiments, the printer device 100 may display a dynamic identifier code, such as a QR code, associated with one of a variety of printer settings including, but not limited to, a printer status, a network IP address, or any other printer device condition. Dynamic identifier codes may be displayed, or printed, by the printer when prompted by the user, or alternatively, may be displayed or printed automatically and/or continuously. In some embodiments, a user, software, or network application may change the apparatus conditions (e.g., attempt to resolve the error, change the printer device settings, etc.). As such, the printer device may communicate (e.g., print or display) multiple dynamically generated identifying codes as the apparatus conditions are changed.

The printer device 100 illustrated in FIG. 1 includes a housing that encloses the graphical user interface 102. The depicted graphical user interface 102 is configured to display a dynamic identifier code 104 such as the illustrated QR code. The depicted graphical user interface 102 may include a liquid crystal display, a light emitting diode display, or any other display capable of providing different dynamic identifier codes, such as quick response codes, each of the dynamic identifier codes corresponding to different printer functions, status indications, and/or error conditions specific to the printer device 100. In addition, the printer device 100 may include an input interface 106, such as a plurality of keys, a keyboard, a mouse, a touchscreen display, and/or any other means for providing input to the printer system device 100.

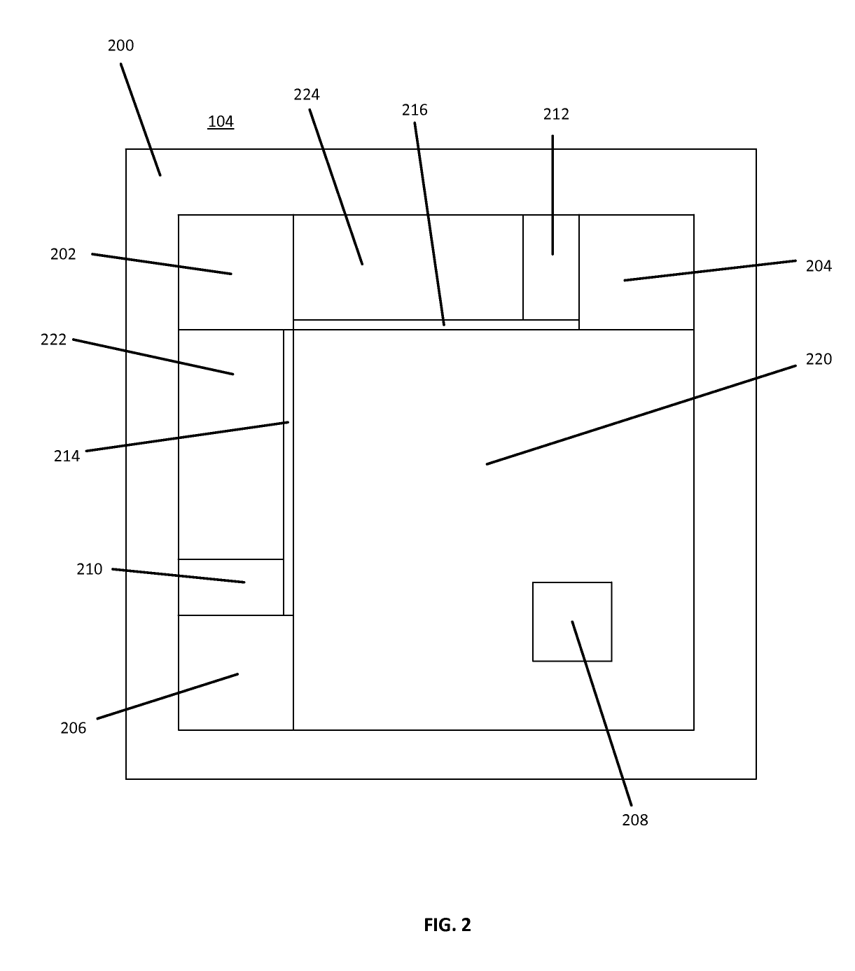

FIG. 2 depicts an exemplary QR code 104 for illustration purposes. As was discussed above, various embodiments of the present invention are now limited to application with QR codes but rather may be used in connection with any dynamic identifier code, which may be apparent to one of ordinary skill in the art in view of this disclosure.

The depicted QR code 104 includes multiple regions or areas containing specific visual indicia, such as black boxes superimposed over a white background, which are encoded to provide machine readable data. The data may be encoded as numeric, alphanumeric, or binary data.

In one embodiment of the present invention, the QR code 104 includes a quiet zone 200 where no encoded data indicia exists. The QR Code 104 may include positional regions 202, 204, 206 and an alignment region 208. The positional regions 202, 204, 206 and alignment region 208 are configured to provide a code reading device a reference for reading and processing the data contained within the QR code 104. In addition, the QR code 104 may include timing regions 214, 216 configured to provide a code reading device additional reference information for reading and processing the data contained within the QR code 104.

The QR code 104 may further include version information 210, 212 configured to provide a code reading device with information related to the QR code version. Various versions of QR codes exist and can provide differing amounts of data depending on the version of the QR code. Earlier versions of QR codes may be able to provide 10-25 alphanumeric characters while later versions of QR codes may be able to provide up to 4296 alphanumeric characters. In the depicted embodiment, the data encoded within the QR code is provided within the data regions 220, 222, 224.

In several embodiments of the present invention, a printer device 100 may be configured to display a QR code 104 comprising information or data encoded therein that is specific to a particular apparatus condition (e.g., printer function, status, error condition, etc.). For example, the printer device 100 may be configured to display a QR code indicating that the printer device has depleted its consumable supply, e.g., its supply of media (e.g., paper, labels, cards, RFID transponders, etc.), ink donor ribbon, intermediate transfer media, and/or other replacement components (e.g., printheads, platen rollers, biasing elements, idler rollers, etc.), and the like.

In other embodiments, the printer device 100 may be configured to display a QR code when the printer device 100 experiences an error condition such as an unsafe or overheated temperature of the printhead or motors, when the printer device has lost a network connection, when the printing operation has been paused, when the printhead is open, when a printer device door is open, and the like.

In one embodiment, the printer device 100 may be configured to display a QR code if the printer has experienced a malfunction or an error. For example, if the printer device 100 experiences an internal jam involving the media supply, the printer device may be configured to display a QR code containing data related to the location and nature of the internal jam.

In another embodiment, a user may wish to obtain additional information regarding the specific printer device, such as the printer device's serial number, model number, contact information for technical support with respect to the printer device, printer device firmware version information, printer device set-up and or configuration information, and/or the like. In such an instance, the user may provide an input to the printer device, such as via the input interface 106, to cause the printer device to generate and display a QR code corresponding to the requested information. Additionally or alternatively, the printer device may be configured to encode such information automatically into all of its QR codes so that such information is readily at hand upon when the QR code is read by the code reading device.

In one embodiment, the printer device 100 may be configured to generate and display a QR code corresponding to the printer settings of the printer device, such as printing media type, printing contrast, print speed, print quality, and/or other printer device settings. This information may be used to confirm proper printer settings, to set up or configure other “mirrored” printers (i.e., printers configured with identical printer settings), or to provide information to technical personnel concerning an error condition as discussed in greater detail below.

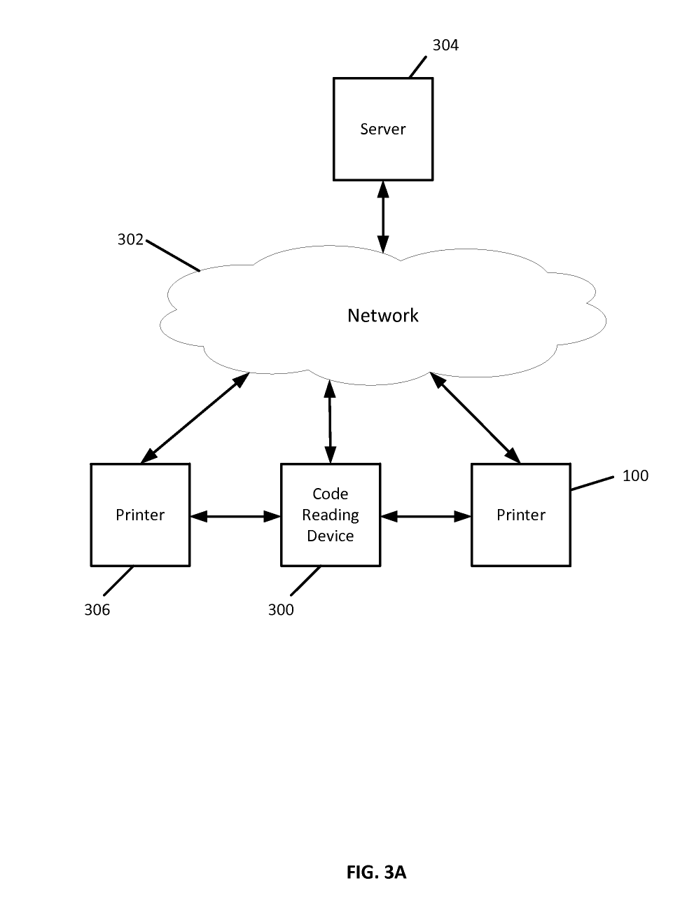

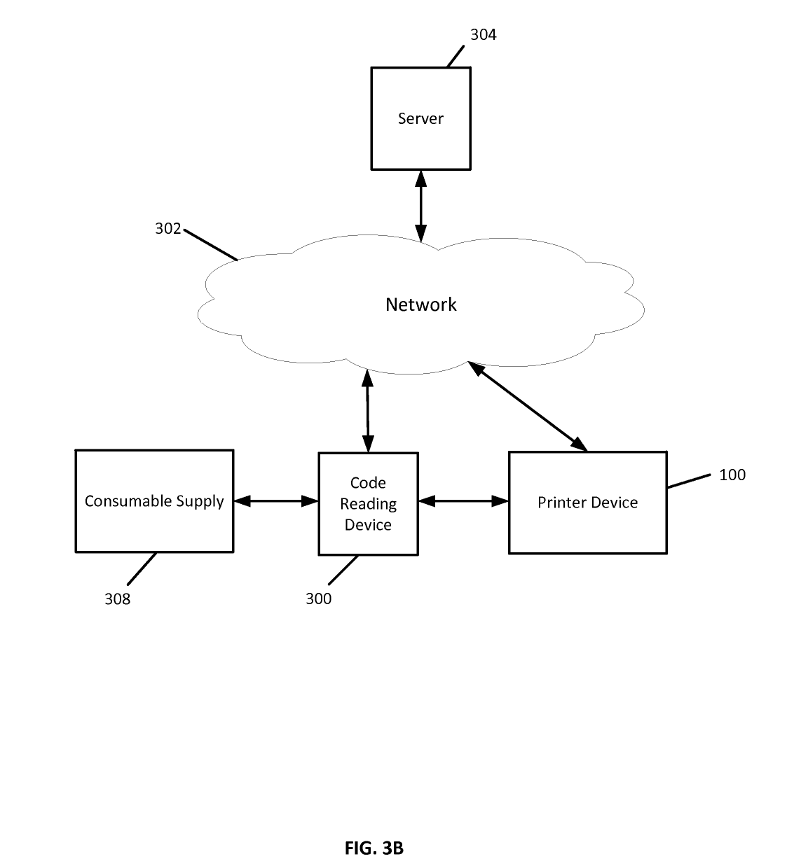

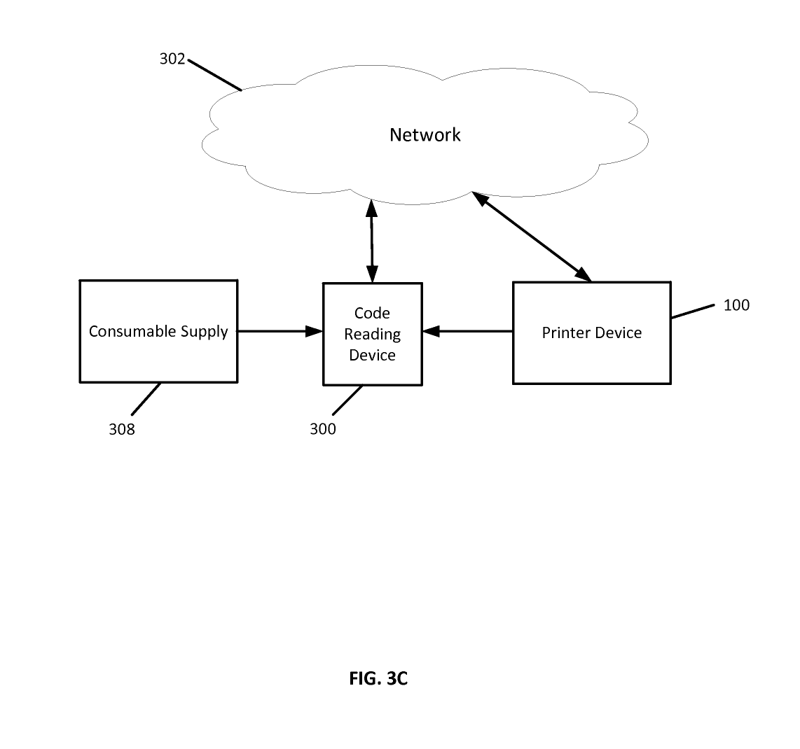

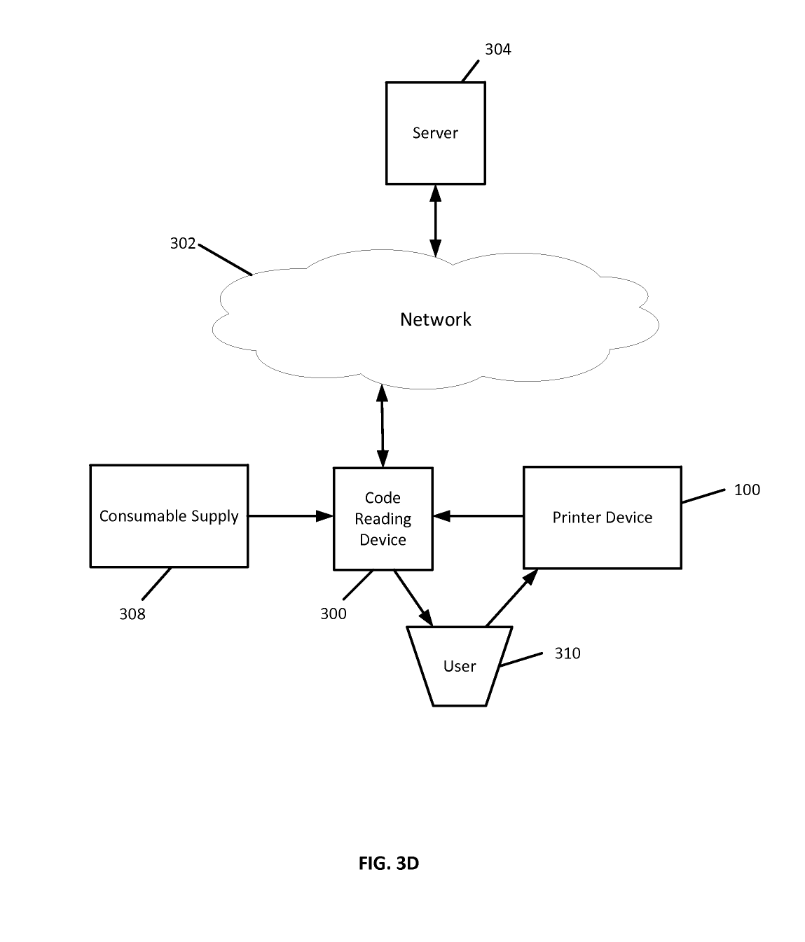

FIG. 3A illustrates a system for providing enhanced printer functionality according to one embodiment of the present invention. The depicted system may include the printer device 100, a code reading device 300, a server 304, and a communications network 302. In another embodiment, the system may further comprise a second printer device 306. The second printer device 306 may be configured to communicate with the code reading device 300. Alternatively or additionally, the second printer device 306 may be configured to communicate with the communication network 302. The code reading device 300 may be configured to communicate with the printer device 100 via a wired or wireless communication connection.

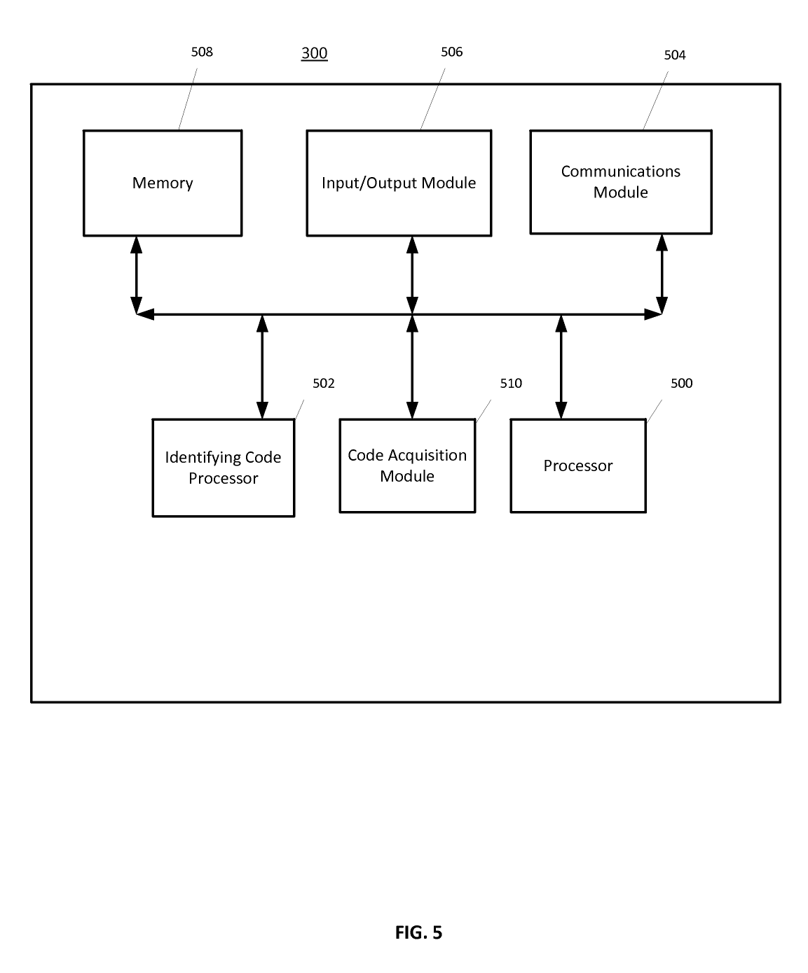

For example, an identifying code emitter 414, such as a code output device (e.g., printer mechanism, display screen, etc.) of the second printer 306 may be prompted to display or print a dynamic identifier code (e.g., a QR code) representing data associated with one or more of its printer settings. A code reading device 300 may be configured to scan, capture, and/or otherwise record a dynamic identifier code displayed by the second printer with a code acquisition module 510 (e.g., imaging system, video camera, etc.), as shown in FIG. 5. In addition, any one of a processor 500, an identifying code processor 502, and a communications module 504 of the code reading device may be configured to process and/or decipher the dynamic identifier code, extract data corresponding to an image or recording of the dynamic identifier code, transmit data corresponding to the first image of the first dynamic identifier code corresponding to the printer settings, and/or retrieve and/or receive data associated with the printer settings of the second printer 306. The communications module 504 of the code reading device 500 may then transmit the data to the first printer 100 to configure the first printer 100 to match the printer settings of the second printer 306.

FIG. 3B illustrates another embodiment of a system for providing enhanced printer configuration functionality. The system comprises a server 304, a network 302, a code reading device 300, a printer device 100, and a consumable supply 308. The consumable supply 308 includes an identifier code, such as a QR code, attached to or otherwise associated therewith (e.g., printed to a label of the supply or supply packaging, etc.).

In one embodiment, the printer device 100 may be configured to display a QR code indicating that the printer device 100 is out of the printer consumable supply. The code reading device 300 may be configured to read the QR code displayed by the printer device 100 and the QR code attached to or associated with the consumable supply 308. In one embodiment, the code reading device 300 may be configured to communicate with the server 304 via the network 302 to verify that the consumable supply 308 may be properly used by the printer device 100. More specifically, the server 304 may compare data deciphered from the consumable supply based QR code to data deciphered from the printer device based QR code to determine whether the intended consumable supply 308 is compatible with the printing device 100.

In another embodiment, i.e., where the printing device 100 requires some degree of re-configuring in order to use a QR code labeled consumable supply 308, the server 304 may provide data and instructions via the network 302 to re-configure the printer device 100 in response to receiving an indication of the consumable supply QR code. For example, in one embodiment the consumable supply may be a direct thermal print media and the server may be configured to retrieve and download, in response to receiving an indication of the QR code associated with the selected media, a specific set of burn tables to the printer device 100 that are optimized for imaging the selected media. As will be apparent to one of ordinary skill in the art, such burn tables may consist of coefficients for algorithms that determine the timing and duration of heat pulses applied during thermal printing from thermal printhead elements, based on a pattern of past, present, and future intended printed indicia arrayed across the printhead.

In another embodiment, a server or a code reading device configured to process a QR code displayed by the printer device may be configured to communicate with the printer device and provide the printer device with settings when using a particular combination of print media and consumable supplies. For example, the server may be configured to communicate to the printer device to adjust the printer settings, such as contrast, media type, media length, media width, printing contrast, printer sensor type (e.g., black mark vs. transmissive sensors), printer sensor settings (e.g., detection threshold), and/or the like. In addition, the server may be configured to communicate to the printer settings associated with the printer ribbon, such as the ribbon width, type, diameter, proper tension of the ribbon, and whether a coated side of the ribbon is faced inwards versus outwards.

FIG. 3C illustrates another embodiment of a system for providing enhanced printer configuration functionality. The depicted system may include the printer device 100, a code reading device 300, a communications network 302, and a consumable supply 308. Accordingly, the code reading device 300 may be configured to capture a QR code displayed by the printer device 100 and a different QR code displayed by the consumable supply 308. Further, the code reading device may be configured to determine the compatibility of the consumable supply 308 with the printer device 100 without a continuous connection to a network or server. Rather, the code reading device may download sufficient data (e.g., perhaps a software application and associated data) for determining compatibility between a printer and a consumable supply at some period of downtime (e.g., perhaps during an overnight battery charge period or other network connected downtime). A user may then scan the dynamic identifier codes of the printer device and consumable supply to determine compatibility or improve printer function without a present need for network or server connectivity (i.e., the data needed resides in the local memory of the code reading device).

FIG. 3D illustrates yet another embodiment of a system for providing enhanced printer functionality. The depicted system may include the printer device 100, a code reading device 300, a communications network 302, a server 304, a consumable supply 308, and a user 310. The code reading device 300 may be configured to capture a dynamic identifier code displayed by the printer device 100 indicating a particular condition such as a printer error. The code reading device 300 may be further configured to communicate with the server 304 via a communications network 302 and obtain information for resolving the printer error condition. In one embodiment, the code reading device 300 may be able to receive (i.e., from a network or server), retrieve (i.e., from local memory), and/or display (i.e., via a display or other interface) instructions for resolving the printer error condition on the code reading device 300, and a user 310 may be able to view, interact, and/or manipulate the code reading device 300 and/or interact, manipulate and/or otherwise instruct the printer device 100 to resolve the error condition, as explained in further detail herein.

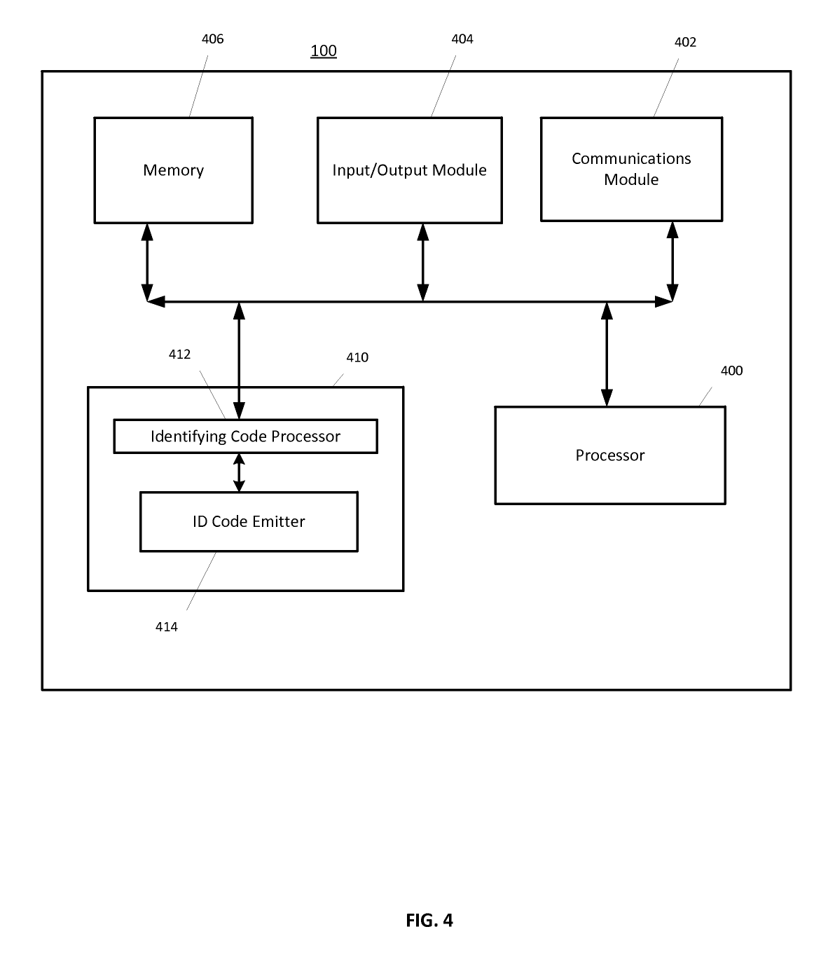

FIG. 4 is a schematic representation of a computer system of a printer device 100 structured in accordance with one embodiment. The depicted computer system comprises one or more of a processor 400, a communications module 402, an input/output module 404, a memory device 406 and a dynamic identifier code module 410. The computer system of the printer device 100 as described herein may be embodied as, for example, circuitry, hardware elements, a computer program product comprising computer-readable program instructions stored on a computer-readable medium, such as the memory 406, that is executable by an appropriately configured processing device, such as the processor 400, or some combination thereof. Further, the input/output module 404 may be configured to send a signal to a code output device for displaying and/or printing a dynamic identifier code.

According to embodiments of the present invention, the printer device 100 may include a dynamic identifier code output device, which may be any device configured to print or display a dynamic identifier code. In one embodiment, the code output device may be a printing mechanism (e.g., a printer controller, printhead, motor-driven platen roller, media handling mechanism, etc.) configured to print the dynamic identifier code onto print media so as to be captured by a code reading device. In another embodiment, the code output device may be the dynamic identifier code module 410, which may further comprise an identifying code processor 412 and an identifying code emitter 414. The identifying code processor 412 may be configured to cause the identifying code emitter 414 to display a QR code corresponding to a particular condition (e.g., a printer error condition, a code displaying condition, and/or the like). In another embodiment, the processor 400 may be configured to direct the identifying code emitter 414 to display the QR code. Further still, the processor 400 of the printer device 100 may be configured to determine if sufficient hardware or software is installed to display a QR code having a sufficient resolution to convey the desired data. In circumstances where software or drivers are insufficient, such may be downloaded from a host or other network entity to support displaying the desired QR code. In circumstances where hardware is insufficient, i.e., a display is insufficient or not present, the printer device may simply print the desired QR code.

In an example embodiment, the processor 400 of the printer device 100 may be configured (e.g., via execution of stored instructions or operation in accordance with programmed instructions) to control the operation of the dynamic identifier code module 410. The processor 400 may be embodied in a number of different ways. For example, the processor 400 may be embodied as a hardware device including one or more of various hardware processing means or devices such as a coprocessor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like.

In an example embodiment, the processor 400 may be configured to execute instructions stored in a memory device (e.g., memory device 406 of FIG. 4) or otherwise accessible to the processor 400. The instructions may be permanent or non-volatile (e.g., firmware) or modifiable (e.g., software) instructions. Alternatively or additionally, the processor 400 may be hardware configured to execute functionality, for example when embodied as an ASIC. As such, whether configured by hardware or software methods, or by a combination thereof, the processor 400 may represent an entity and means (e.g., physically embodied in circuitry) capable of performing operations according to embodiments of the present invention while configured accordingly. Thus, for example, when the processor 400 is embodied as an ASIC, FPGA or the like, the processor 400 may be specifically configured hardware for conducting the operations described herein. Alternatively, as another example, when the processor 400 is embodied as a hardware executor of software or firmware instructions, the instructions may specifically configure the processor 400 to perform the algorithms and/or operations described herein when the instructions are executed.

The processor 400 may include, among other things, a clock, an arithmetic logic unit (ALU) and logic gates configured to support operation of the processor 400. Similarly, the processor 500, 600 of the code reading device 300 and the server 304 respectively, may be configured as set forth above but configured specifically for the purposes and functions described herein.

The memory device 406 may include, for example, one or more volatile and/or non-volatile memories. In other words, for example, the memory device 406 may be a non-transitory electronic storage device (e.g., a computer-readable storage medium) comprising gates (e.g., logic gates) configured to store data (e.g., bits) that may be retrievable by a machine (e.g., a computing device including a processor such as processor 400). The memory device 406 may be configured to store information, data, applications, instructions or the like for enabling the printer device 100 to carry out various functions in accordance with example embodiments. For example, the memory device 406 may be configured to buffer input data for processing by the processor 400. Additionally or alternatively, the memory device 406 may be configured to store instructions for execution by the processor 400.

In this regard, instructions stored on the memory device 406 may be specifically tailored to direct the operation of the dynamic identifier code module 410 via the processor 400. The memory device 406 may be an electronic storage device (e.g., a computer-readable storage medium) comprising gates configured to store data (e.g., bits) that may be retrievable by a machine (e.g., a computing device including a processor such as processor 400). The memory device 406 may be configured to store information, data, applications, instructions or the like, which can be organized in any manner (including as various types of functionality profiles), that enable the dynamic identifier code module 410 to carry out various functions in accordance with exemplary embodiments of the present invention. For example, the memory device 406 may be configured to buffer input data for processing by the processor 400. Additionally or alternatively, the memory device 406 may be configured to store instructions for execution by the processor 400. Similarly, the memory devices 508, 608 of the code reading device 304 and the server 300 may include processors and memory having similar structures and functionality as described above with respect to the printer device processor 400 and memory 406.

The communications module 402 may be any means such as a device or circuitry embodied in either hardware, or a combination of hardware and software that is configured to receive and/or transmit data from/to a network and/or any other device or module in wire or wireless communication with printer device 100. The communications module 402 may include, for example, an antenna (or multiple antennas) and supporting hardware and/or software for enabling communications with network 302 or other devices. Additionally, to support network communications, the communications module 402 may support the implementation of a system-wide synchronized clock. Synchronization of the clock may be maintained via a clock signal. Code reading devices and printing devices may include real time clock circuitry to support the synchronized clock and to regulate the use of precise communications windows. Additionally or alternatively, the communications module 402 may include an unsynchronized clock.

In an example embodiment, the communications module 402 may support communication via one or more different communication protocols or methods. In some embodiments, e.g., mobile printing applications, the communications module 402 may be configured to support relatively low power, which may yield a relatively small communication proximity area. As such, for example, a low power and short range communication radio (e.g., radio transmitter/receiver) may be included in the communication module 402. In some examples, a radio transmitter/receiver may include a transmitter and corresponding receiver configured to support radio frequency (RF) communication in accordance with an IEEE (Institute of Electrical and Electronics Engineers) communication standards such as IEEE 802.11, which may yield a relatively larger communication proximity area. For example, some embodiments may employ Bluetooth, Wibree, ultra-wideband (UWB), WirelessHART, MiWi or other communication standards employing relatively short range wireless communication in a network such as a wireless personal area network (WPAN). According to some example embodiments, the communications module 402 may be configured to support an Internet Protocol version 6 (IPV6) stack. Regardless of the protocol, the communications module 402 may be configured to utilize a network identifier or network key, for example stored in the memory device 406, such as a personal area network (PAN) identifier. Similarly, the communication modules 504, 604 of the code reading device 304 and the server 300 respectively may include similar structure and perform similar functions as the communication module 402.

In an alternative embodiment, the printer may be configured to include a processor that may run applications (e.g., software, firmware, etc.), such as an application for providing image data of a dynamic identifier code and/or providing enhanced printer and/or code reading device functionality using data provided by or otherwise associated with the dynamic identifier code. Additionally, the printer may include a memory (e.g., a local memory or the like) for storing applications and/or user or printer information. Further, the printer may include a database of information, such as printer settings, printer identifiers, printer users and/or the like. In another embodiment, the printer may include a user input interface configured to allow a user to provide, edit or modify data or applications stored to the printer device to edit/modify user information related to the application and/or printer. Alternatively, or additionally, the printer may include a user interface that may be configured to display or otherwise communicate information or instructions to the user. Further, the printer may include communication capabilities (e.g. wired or wireless communication capabilities, etc.) to talk to, send data to, and/or receive data and instructions from another printer, a code reading device, a network, a server, or any combination thereof.

As shown in FIG. 5, the code reading device 300 may include various means for providing enhanced printer functionality as described in detail herein. In some embodiments, the code reading device 300 may be a smartphone, a tablet computer, a mobile computing device, a barcode reader, an RFID reader, a mobile terminal, a laptop computer with a built-in or connected camera(s), a rasterizing laser scanner and/or the like. The code reading device 300 may include one or more of a processor 500, a communications module 504, an input/output module 506, a memory device 508, an identifying code processor 502, and a code acquisition module 510. The code acquisition module 510 may be configured, in conjunction with the input/output module 506, to capture image data corresponding to a QR code displayed by a printer device according to embodiments of the present invention. For example, the code acquisition module may be a camera, a video camera, or any other means for capturing the image data corresponding to the QR code displayed by the printer device.

According to one embodiment of the present invention, the code reading device 300 may include a communications module 504 for communicating with at least one printer device and/or a server via a network. The communications module 504 may be configured to transmit data related to the image data of the QR code captured by the code acquisition module 510. In one example embodiment, the code reading device 300 may be configured to transmit a captured image file (e.g., a bitmap, jpeg, or other image file) of the QR code to the server for interpretation and processing at the server. In another embodiment, the code reading device 300 may be configured to locally (e.g., at the code reading device) interpret and process, either fully or partly, via the identifying code processor 502, the image data into text, binary, or other data format that may then be transmitted to the server via the communications module 504.

According to another embodiment, the code reading device 300 may be configured to capture video or image data of the printer device and may be further configured to identify the printer device before capturing image data of the QR code. Thus, the code reading device may be configured to determine the identity of a printer device by a printer model number and/or by the printer's physical shape, design, size, structure, and/or the like. For example, the code reading device may be configured to capture an image of a printer device and transmit image data corresponding to the captured image of the printer device to a server via the communications module. The code reading device may also be configured to receive data corresponding to the identity of the printer device from the server before the code reading device captures image data of the QR code. Accordingly, the code reading device may be configured to capture image data corresponding to the QR code after having identified the printer device. As such, the code reading device may be configured to capture image data corresponding to a QR code after having identified the printer device. Thus, the code reading device may be configured to capture image data corresponding to a QR code displayed by a first printer device, capture image data corresponding to a QR code displayed by a second printer device, wherein the QR code displayed by the first and second printer are identical, and may be further configured to determine differing printer device conditions based at least in part on receiving data corresponding to the identity of the printer device prior to capturing the image data corresponding to the respective QR codes. Such functionality may be used in connection with the augmented reality (AR) embodiments described in greater detail below. Alternatively, the code reading device may be configured to identify the printer device by capturing video or image data of the printer model number or the printer's physical shape, design, size, structure, and/or the like concurrently with capturing image data of the QR code.

According to another embodiment, the code reading device may be configured to transmit data in addition to the image data of the QR code. For example, the code reading device may contain information corresponding to the user of the code reading device and the printer device and/or the printer device itself, such as the user's name, contact information, when and where the user acquired or purchased the printer device, whether the printer device includes a warranty, information indicating when the user last contacted customer support, who the user contacted, or any number of individualized data related to the user. Further, the code reading device and the printer device and/or the printer device itself may contain additional information, such as technical service contact information, authorized reseller information, printer device usage information, user location and language preference information and the like.

In one embodiment, the code reading device may be configured to contain data indicating that a user is a “premium” user. When the user captures image data of the QR code displayed by the printer and transmits the image data to a server, the code reading device may further transmit data indicating the user's premium status. Accordingly, when the server transmits data or instructions to the code reading device for resolving the condition, the server may direct a web browser of the code reading device to a website only accessible to premium users. Targeted instructions and other messages for premium users may thus be provided.

In another embodiment, the printer device may be configured to generate and display QR codes containing user data in addition to data associated with a printer condition. In such embodiments, the code reading device may be used in connection with data and instructions retrieved from a network or server to display user specific messages or instructions to improve printer functionality.

In still another embodiment, user specific data, such as a user identity data, may be stored locally at the code reading device, on the network and/or the server. For example, in one embodiment, a user may use a code reading device to read and/or capture a QR code displayed by a printer device with a code acquisition module. The processor of a code reading device may then process the QR code into a first image data and associates the first image data with a user ID prior to transmitting the first image data to the network or server via a communications module. In another embodiment, a user identity data may be transmitted via a communications module of the code reading device prior to transmitting the first image data. Upon receipt of the first image data including data corresponding to the user ID, a server may, alone or in combination with the code reading device, perform one of a variety of user targeted operations. For example, the processor of a server may be configured to cause user contact information and information associated with the printer device condition (e.g., a description of a printing error message) to a technical support representative (e.g., perhaps by email, text message, etc.). The technical support representative may thus be able to call the user and efficiently resolve any errors having already been equipped with the necessary background information related to the printer and the error condition without having to ask the user to explain the situation.

In another embodiment, the printer may be configured with user information so as to display an individualized dynamic QR code depending on the user. For example, when a more technically sophisticated user (e.g., perhaps a field technical representative) encounters a problem with the printer device, the printer device may be configured to display a QR code with more technically robust data related to the problem (e.g., robust printer settings or diagnostic data that may be too detailed or complex to be easily understood by a layperson). This may stand in contrast to the more limited data (e.g., limited diagnostic data and technical representative contact information) encoded in a QR code that would be displayed to unsophisticated users encountering the same problem.

In still another embodiment, the QR code displayed by the printing device may not be user specific, however, users having greater technical sophistication may be able to download enhanced sets of data and instructions from the network or server. For example, when a code reading device transmits condition data to a network or server with a user ID, the network or server may be configured to recognize the user as a technical service representative and thus download complex and technically detailed instructions to the code reading device. Once again, in contrast, if a non-sophisticated user encounters the same problem, the network or server may download a more limited set of instructions accompanied perhaps with contact information for a technical representative.

As will be appreciated by one of skill in the art in view of this disclosure, images captured by the code reading device may be processed or deciphered locally at the code reading device, remotely at the network and/or server, or some combination thereof. In one embodiment, for example, the code receiving device may transmit image data corresponding to a QR code image to the server and/or network for processing. In another embodiment, the code receiving device may process the QR code image, determine a printer device condition based at least in part on the QR code image, and transmit condition data to the network or server, alone or in combination with the image data associated with the QR code image.

In still other embodiments, the code reading device, the network and/or server, or some combination thereof may act to resolve an apparatus condition that is associated with a dynamic identifier code. For example, in one embodiment, the network and/or server may receive the captured QR code image file or the text, binary, or other data format transmission from the code reading device and may respond in some fashion to the received information (e.g., transmitting data or instructions to the printer device directly via a network connection or indirectly via the code reading device to resolve the apparatus condition, e.g., a printer error or other condition that caused the display of the QR code). In another embodiment, i.e., in circumstances where the code reading device is configured to interpret and process the captured QR code image data, the code reading device may respond in some fashion (e.g., transmitting data or instructions to the printer device or displaying instructions at the code reading device for resolving a printer error function or other condition that caused the display of the QR code) to the data received by interpreting the QR code.

According to one embodiment of the present invention, the code reading device may be associated with a user and may be further configured to store data (e.g., via a local memory or the like) associated with the user or other data. The code reading device may be further configured to store and/or run an application (e.g., software, firmware, etc.) for capturing QR code image data and/or providing enhanced printer functionality, such as controlling printer functions from the code reading device. The code reading device may be further capable of detecting, capturing and processing (e.g., extracting data from) the dynamic identifier code, such as a QR code.

In another embodiment, the code reading device may include a processor that may run applications (e.g., software, firmware, etc.), such as an application for capturing image data of a dynamic identifier code and/or providing enhanced printer and/or code reading device functionality using data extracted from or otherwise associated with the dynamic identifier code. Additionally, the code reading device may include a memory for storing applications, data, and/or user or printer information. Further, the code reading device may include a database of information, such as printer settings, printer identifiers, printer users and/or the like.

In one embodiment, the code reading device may be configured to decode and/or process the dynamic identifier code so as to extract the data encoded within the graphical symbology of the dynamic identifier code. In another embodiment, the code reading device may include a user input interface configured to allow a user to provide, edit or modify data or applications stored to the code reading device or to edit/modify user information related to the application and/or printer. Alternatively, or additionally, the code reading device may include a user interface which may be configured to display or otherwise communicate information or instructions to the user. Further, the code reading device may include communication capabilities (e.g., wired or wireless, etc.) to talk to, send data to, and/or receive data and instructions from a printer, a network, a server, or any combination thereof.

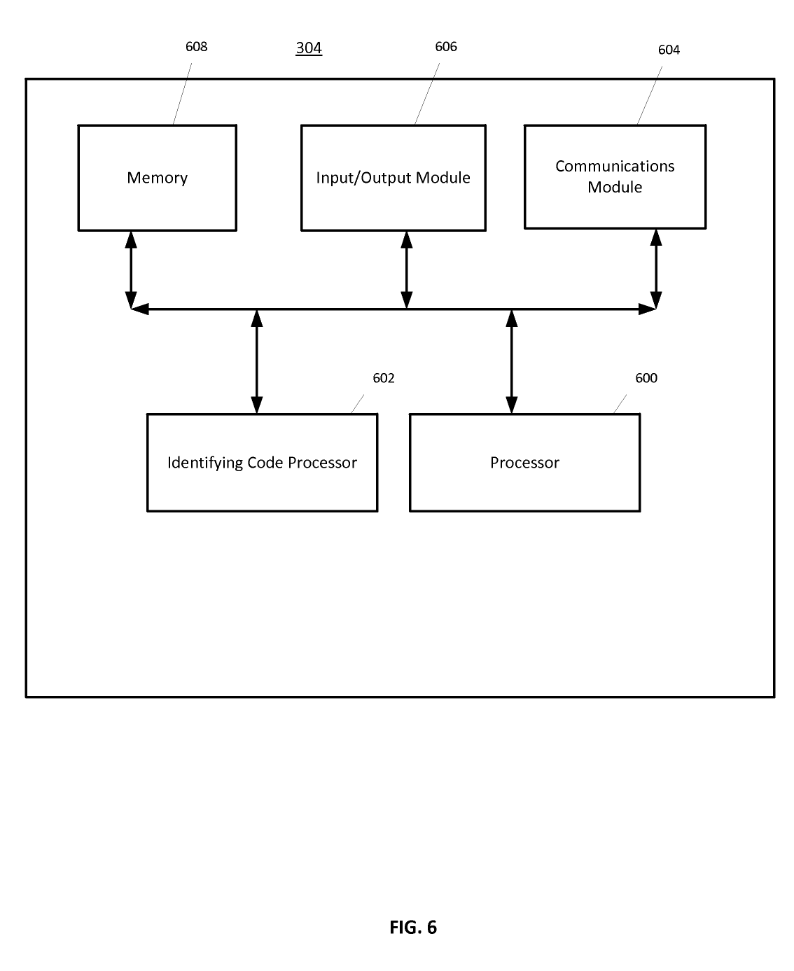

FIG. 6 illustrates a server 304 according to one embodiment of the present invention for providing enhanced printer functionality as described herein. The server 304 may include a computer system for providing the enhanced functionality including one or more of a processor 600, an identifying code processor 602, a communications module 604, an input/output module 606 and/or a memory device 608. In one embodiment, the computer system for providing enhanced printer functionality may include a server 304, and the computer system may be embodied as, for example, circuitry, hardware elements, a computer program product comprising computer-readable program instructions stored on a computer-readable medium, such as the memory 608, that is executable by the an appropriately configured processing device, such as the processor 600, or some combination thereof.

The communications module 604 may be configured to communicate, for example, with at least one printer device 100 and/or a code reading device 300 via a wired or wireless network. The communications module 604 may be configured to receive data corresponding to a QR code, the QR code including data related to a specific printer, printer error condition, and/or any condition prompting the printer device to display a QR code. Further, the communications module 604 may be in communication with the processor 600, memory 608, and/or identifying code processor 602 so as to provide enhanced printer functionality.

In one embodiment, the identifying code processor 602 may be configured to identify the specific QR code displayed by the printer device. The identifying code processor 602 may communicate with the memory device 608 and the communications module 603 so as to provide the printer device with instructional data for resolving the condition that caused the QR code to be displayed by the printer device. According to one embodiment, the communications module 604 of the server 304 may be configured to communicate with the code reading device 300 via a network so as to provide the code reading device with the instructional data for resolving the condition that caused the QR code to be displayed by the printer device. Alternatively, the communications module 604 may be configured to communicate with the printer device directly via a network so as to provide the printer with the proper instructional data for resolving the condition that caused the printer device to display the QR code.

Further still, in another embodiment, the server may include a processor that may run applications (e.g., software, firmware, etc.), such as an application for capturing image data of a dynamic identifier code and/or providing enhanced printer and/or code reading device functionality using data extracted from or otherwise associated with the dynamic identifier code. Additionally, the server may include a memory for storing applications, data, and/or user or printer information. In addition, the server may include a database of information, such as printer settings, printer identifiers, printer users and/or the like. In one embodiment, the server may be configured to decode and/or process the dynamic identifier code so as to extract the data encoded within the graphical symbology of the dynamic identifier code. In another embodiment, the server may include a user input interface configured to allow a user to provide, edit or modify data or applications stored to server or code reading device or to edit/modify user information related to the application and/or printer. Alternatively, or additionally, the server may include a user interface which may be configured to display or otherwise communicate information or instructions to the user. Further, the server may include communication capabilities (e.g. wired or wireless, etc.) to talk to, send data to, and/or receive data and instructions from at least one printer, a network, a code reading device, or any combination thereof.

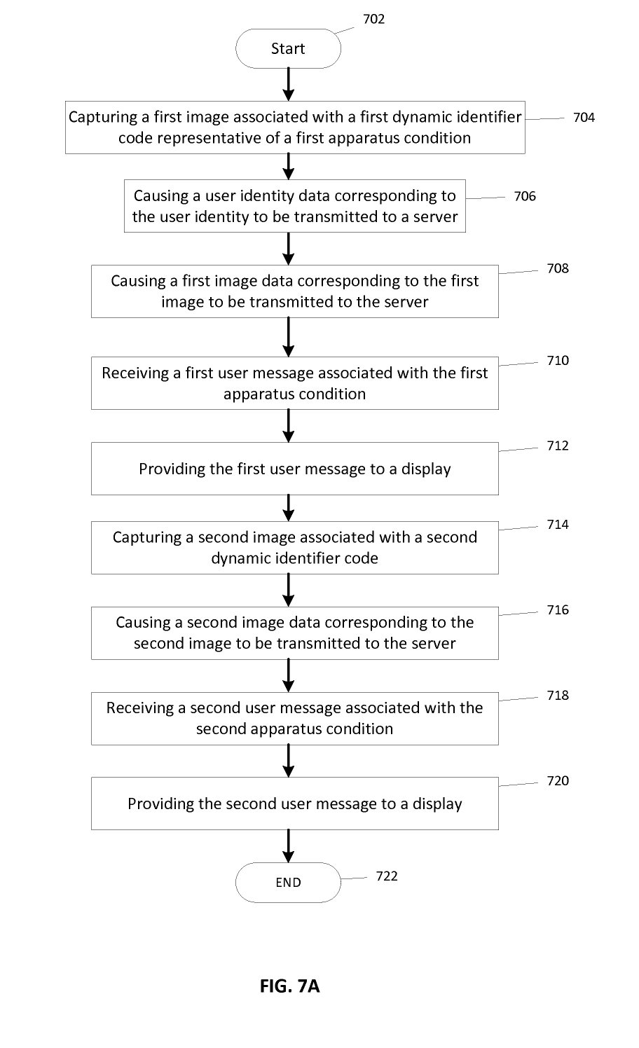

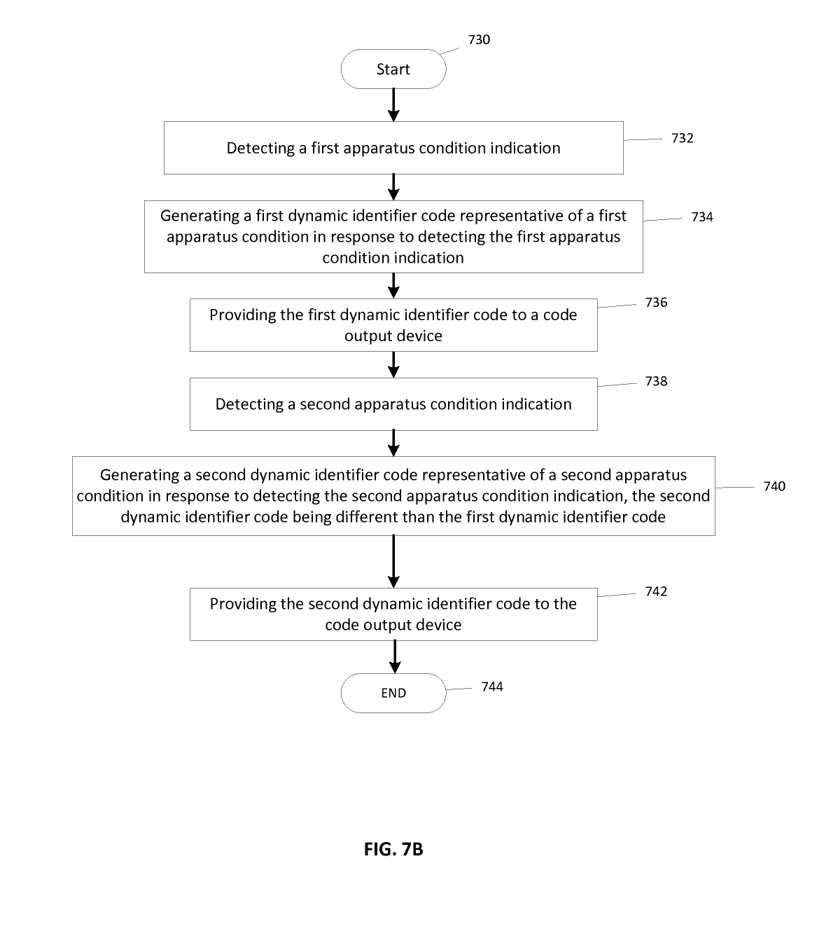

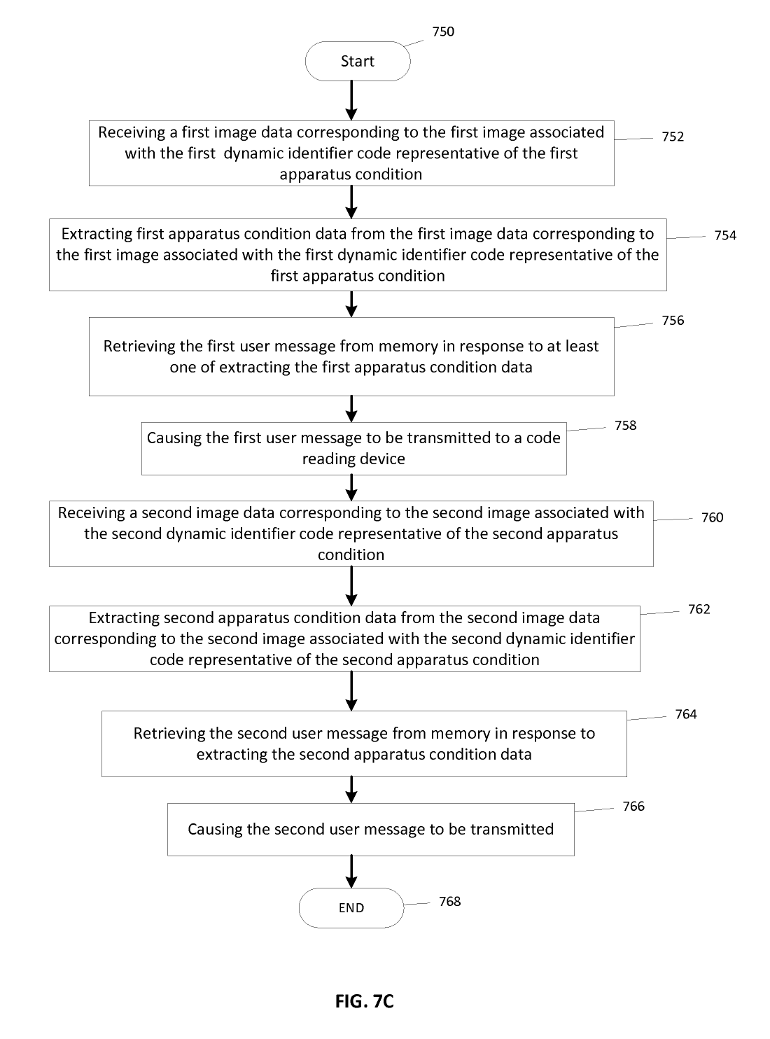

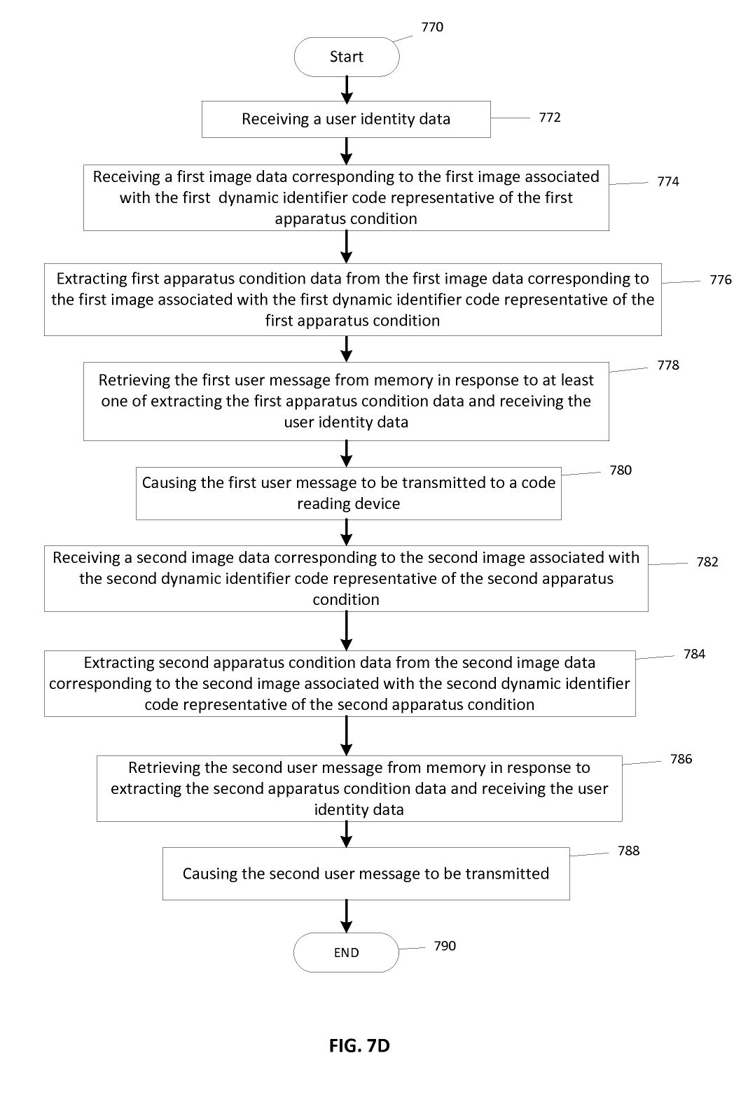

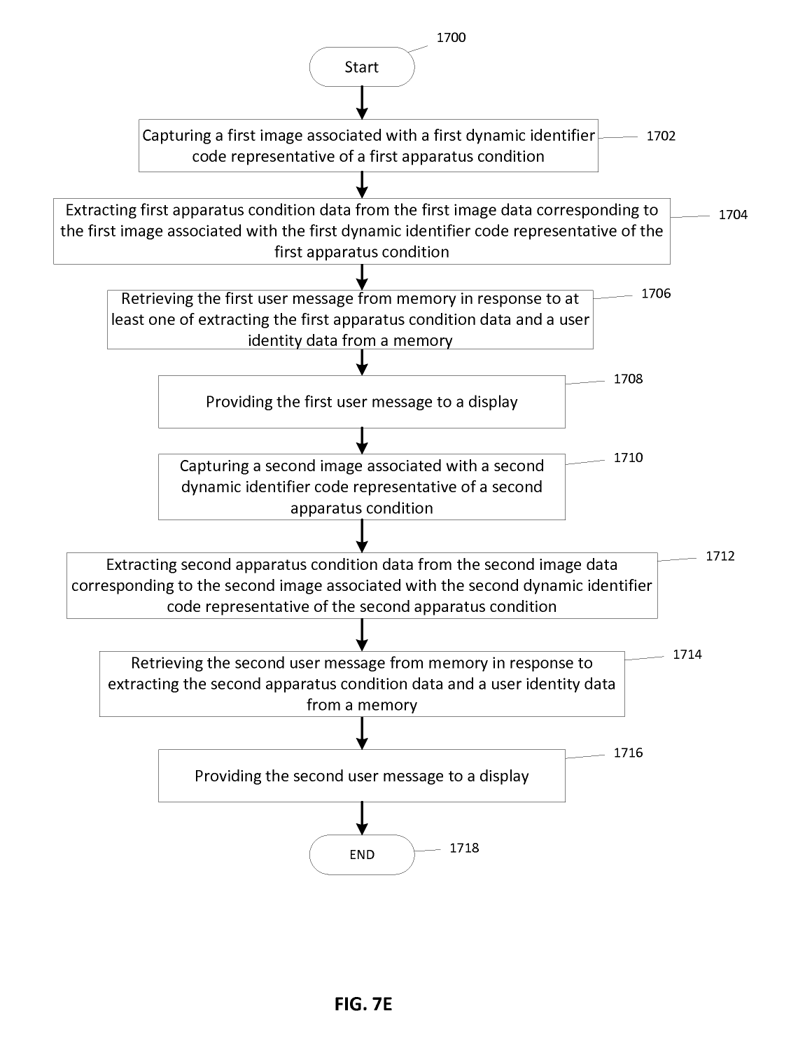

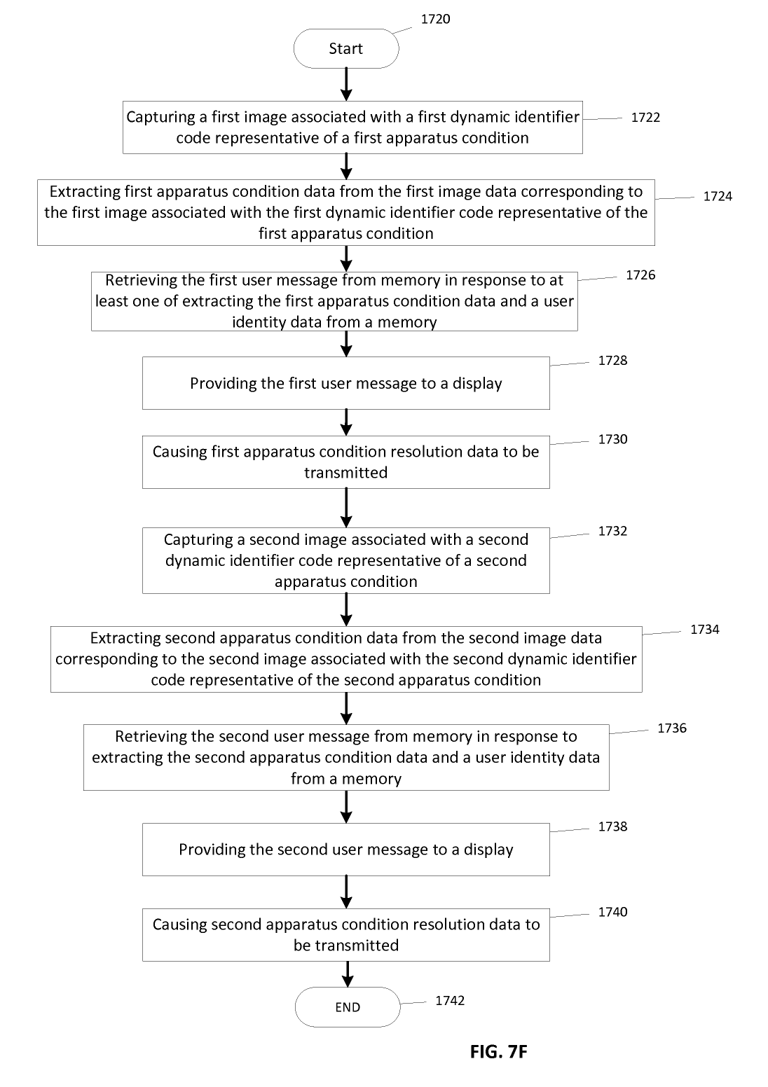

One embodiment for providing enhanced printer functionality with a code reading device is illustrated by the flowchart of FIG. 7A. A method for providing enhanced printer functionality starts at Step 702. A code reading device, such as the one illustrated in FIG. 5, may include a code acquisition module 510 that captures a first image associated with a first dynamic identifier code displayed by a code output device, such as the identifying code emitter 414, of a printer device as illustrated in FIG. 4, at Step 704. For example, a printer may display a first dynamic identifier code corresponding to first printer condition, such as a printer motor being inoperable. At Step 706, a processor 500 and/or a communications module 504 of a code reading device may cause a user identity data, which may be stored in a memory 508, to be transmitted to a server, such as a server illustrated in FIG. 6. In some embodiments, the user identity data may include data corresponding to the user's technical experience and/or ability to repair the printer.

According to some embodiments, a processor 500 and/or a communications module 504 of a code reading device may cause a first image data corresponding to the first image captured by the code acquisition module to be transmitted to the server at Step 708. In some embodiments, the processor and/or communications module may be configured to process, condition, and/or modify the first image data to include the user identity data, and may be further configured to transmit the conditioned first image data to the server. According to some embodiments, the processor and/or a communications module may be configured to receive a first user message associated with the first apparatus condition from a server at Step 710. For example, the first user message may include instructions for the user to contact technical support and technical representative contact information in an instance where the user identity data corresponds to a technically unsophisticated user. In contrast, when the user identity data corresponds to a technically sophisticated user, the first user message may include robust printer settings, diagnostic data that may be too detailed or complex to be easily understood by a layperson, and/or the like. At Step 712, the processor 500 and/or an identifying code processor 502 of a code reading device may provide the first user message to an input/output module 506, such as a display.

According to some embodiments, the code acquisition module 510 may capture a second image associated with a second dynamic identifier code displayed by the input/output module 404 of the printer, such as the one illustrated in FIG. 4, at Step 714. The second dynamic identifier code may be different from the first dynamic identifier code, and further may correspond to a second apparatus condition. For example, the second apparatus condition may correspond to an indication that a printer media supply has been depleted. At Step 716, a processor 500 and/or a communications module 504 of a code reading device may cause a second image data corresponding to the second image captured by the code acquisition module to be transmitted to the server. In some embodiments, the processor and/or a communications module may be configured to receive a second user message associated with the second apparatus condition from a server at Step 718. At Step 720, the processor 500 and/or an identifying code processor 502 of a code reading device may provide the second user message to an input/output module 506, such as a display. For example, the second user message displayed to the display may include a URL address for directing a web browser of the code reading device to a website for purchasing additional printer media supplies. The process then ends at Step 722.

FIG. 7B depicts an alternative embodiment for providing enhanced printer functionality with a printer, such as the printer illustrated in FIG. 4. The process starts at Step 730. At Step 732, a processor 400 of the printer illustrated in FIG. 4 may detect a first apparatus condition indication. For example, a printer may include a number of sensors configured to communicate with the processor 400. According to some embodiments, the processor may be configured to communicate with at least one of a plurality of printhead sensors, printer motor sensors, printer housing sensors, printer media supply sensors, and/or the like. As such, the sensors may be configured to provide the processor 400 with data corresponding to various printer conditions and/or events. At Step 734, the processor may be configured to generate a first dynamic identifier code representative of a first apparatus condition in response to detecting the first apparatus condition indication. For example, the processor 400 may be configured to generate a first dynamic identifier code when a printer housing sensor provides the processor with a signal that a printer door is opened. According to some embodiments, an identifying code processor 412, may be configured to generate the first dynamic identifier code at Step 734. In some embodiments, the processor and/or identifying code processor may be configured to provide the first dynamic identifier code to a code output device, such as the identifying code emitter 414, as illustrated in FIG. 4, at Step 736. For example, a code output device, such a display, may be provided with the first dynamic identifier code associated with a printer door being opened by a processor and/or identifying code processor so as to be captured, scanned, and/or otherwise recorded by a code reading device.

According to some embodiments, a processor may be configured to detect a second apparatus condition at Step 738. The processor and/or the identifying code processor may be configured to then generate a second dynamic identifier code representative of a second apparatus condition in response to detecting the second apparatus condition indication. The processor and/or identifying code processor may be configured to provide the second dynamic identifier code to the code output device, such as an identifying code emitter, at Step 742. The process may then end at Step 744.

FIG. 7C depicts yet another alternative embodiment for providing enhanced printer functionality with a server, such as one illustrated in FIG. 6. The process starts at Step 750. At Step 752, a communications module 604 of the server illustrated in FIG. 6 may receive a first image data corresponding to the first image associated with the first dynamic identifier code representative of the first apparatus condition from a code reading device, such as one illustrated in FIG. 5. A processor 600 and/or an identifying code processor 602 may be configured to extract first apparatus condition data from the first image data corresponding to the first image associated with the first dynamic identifier code representative of the first apparatus condition at Step 754. In some embodiments, the processor 600 and/or an identifying code processor 602 may be configured to retrieve a first user message stored in a memory 608 in response to, in part, extracting the first apparatus condition data at Step 756. Accordingly, the processor, the identifying code processor, and/or the communications module may be configured to cause the first user message to be transmitted to a code reading device at Step 758.

Additionally and/or alternatively, the processor, the identifying code processor, and/or the communications module may be configured to cause the first user message to be transmitted to the printer. According to some embodiments, the processor, the identifying code processor, and/or the communications module may be configured to cause a first apparatus condition resolution data to be transmitted to a printer and/or the code reading device so as to resolve the first apparatus condition that caused the printer to display the first dynamic identifier code, wherein the first apparatus condition resolution data is associated with the first user message.

At Step 760, a communications module may receive a second image data corresponding to the second image associated with the second dynamic identifier code representative of the second apparatus condition from a code reading device, such as one illustrated in FIG. 5. A processor 600 and/or an identifying code processor 602 may be configured to extract second apparatus condition data from a second image data corresponding to the second image associated with the second dynamic identifier code representative of the second apparatus condition at Step 762. In some embodiments, the processor 600 and/or an identifying code processor 602 may be configured to retrieve a second user message stored in a memory 608 in response to, in part, extracting the second apparatus condition data. Accordingly, the processor, the identifying code processor, and/or the communications module may be configured to cause the second user message to be transmitted to a code reading device at Step 766.

Additionally and/or alternatively, the processor, the identifying code processor, and/or the communications module may be configured to cause the second user message to be transmitted to the printer. According to some embodiments, the processor, the identifying code processor, and/or the communications module may be configured to cause a second apparatus condition resolution data to be transmitted to a printer and/or the code reading device so as to resolve the second apparatus condition that caused the printer to display the second dynamic identifier code, wherein the second apparatus condition resolution data is associated with the second user message. The process ends at Step 768.

FIG. 7D depicts yet another alternative embodiment for providing enhanced printer functionality with a server, such as one illustrated in FIG. 6. The process starts at Step 770. At Step 772, a communications module 604 of the server illustrated in FIG. 6 may receive a user identity data from a code reading device and/or a printer, as illustrated in FIGS. 4 and 5. In some embodiments, a communications module 604 of the server may receive a first image data corresponding to the first image associated with the first dynamic identifier code representative of the first apparatus condition from a code reading device, such as one illustrated in FIG. 5, at Step 774. A processor 600 and/or an identifying code processor 602 may be configured to extract first apparatus condition data from a first image data corresponding to the first image associated with the first dynamic identifier code representative of the first apparatus condition at Step 776.

In some embodiments, the processor 600 and/or an identifying code processor 602 may be configured to retrieve a first user message stored in a memory 608 in response to extracting the first apparatus condition data and receiving the user identity data at Step 778. For example, in an instance where the user identity data is associated with a user that may have limited technical skills and/or knowledge, the processor and/or identifying code processor may be configured to retrieve a first user message stored in a memory, wherein the message includes basic instructions for a user to contact technical support representative (e.g., perhaps by email, text message, etc.) by providing technical support representative contact information (e.g., email addresses, phone numbers, etc.). In some embodiments, wherein the user identity data is associated with a more technically sophisticated user (e.g., perhaps a field technical representative), the processor and/or identifying code processor may be configured to retrieve a first user message stored in a memory, wherein the message includes more technically robust instructions (e.g., robust printer setting changes, diagnostic tests, etc. that may be too detailed or complex to be easily understood by a layperson). Accordingly, the processor, the identifying code processor, and/or the communications module may be configured to cause the first user message to be transmitted to a code reading device at Step 780, wherein the first user message extracted may be in response to receiving the user identity data.

At Step 782, a communications module may receive a second image data corresponding to the second image associated with the second dynamic identifier code representative of the second apparatus condition from a code reading device, such as one illustrated in FIG. 5. A processor 600 and/or an identifying code processor 602 may be configured to extract second apparatus condition data from a second image data corresponding to the second image associated with the second dynamic identifier code representative of the second apparatus condition at Step 784. In some embodiments, the processor 600 and/or an identifying code processor 602 may be configured to retrieve a second user message stored in a memory 608 in response to extracting the second apparatus condition data and receiving the user identity data, as described above, at Step 786. Accordingly, the processor, the identifying code processor, and/or the communications module may be configured to cause the second user message to be transmitted to a code reading device at Step 788. The process ends at Step 790.

One embodiment for providing enhanced printer functionality with a code reading device is illustrated by the flowchart of FIG. 7E. A method for providing enhanced printer functionality starts at Step 1700. A code reading device, such as the one illustrated in FIG. 5, may include a code acquisition module 510 that captures a first image associated with a first dynamic identifier code displayed by a code output device, such as an identifying code emitter 414 of a printer, such as the one illustrated in FIG. 4, at Step 1702. At Step 1704, a processor 500 and/or an identifying code processor 502 may be configured to extract a first apparatus condition data from the first image data corresponding to the first image, which is associated with the first dynamic identifier code representative of the first apparatus condition. According to some embodiments, a processor 500 and/or an identifying code processor 502 of a code reading device may be configured to retrieve a first user message from a memory 508 of the code reading device in response to at least one of extracting the first apparatus condition data and a user identity data, which may also be stored in memory 508, at Step 1706. At Step 1708, the processor 500 and/or an identifying code processor 502 of a code reading device may provide the first user message to an input/output module 506, such as a display.

According to some embodiments, the code acquisition module 510 may capture a second image associated with a second dynamic identifier code displayed by the code output device of the printer, such as the one illustrated in FIG. 4, at Step 1710. At Step 1712, a processor 500 and/or an identifying code processor 502 may be configured to extract a second apparatus condition data from the second image data corresponding to the second image, which is associated with the second dynamic identifier code representative of the second apparatus condition. According to some embodiments, a processor 500 and/or an identifying code processor 502 of a code reading device may be configured to retrieve a second user message from a memory 508 of the code reading device in response to at least one of extracting the second apparatus condition data and a user identity data, which may also be stored in memory 508, at Step 1714. At Step 1716, the processor 500 and/or an identifying code processor 502 of a code reading device may provide the second user message to an input/output module 506, such as a display. The process then ends at Step 1718.

FIG. 7F illustrates a flowchart of one embodiment for providing enhanced printer functionality with a code reading device. A method for providing enhanced printer functionality starts at Step 1720. A code reading device, such as the one illustrated in FIG. 5, may include a code acquisition module 510 that captures a first image associated with a first dynamic identifier code displayed by an input/output module 404 of a printer, such as the one illustrated in FIG. 4, at Step 1722. At Step 1724, a processor 500 and/or an identifying code processor 502 may be configured to extract a first apparatus condition data from the first image data corresponding to the first image, which is associated with the first dynamic identifier code representative of the first apparatus condition. According to some embodiments, a processor 500 and/or an identifying code processor 502 of a code reading device may be configured to retrieve a first user message from a memory 508 of the code reading device in response to at least one of extracting the first apparatus condition data and a user identity data, which may also be stored in memory 508, at Step 1726. At Step 1728, the processor 500 and/or an identifying code processor 502 of a code reading device may provide the first user message to an input/output module 506, such as a display. Additionally and/or alternatively, any one of the processor 500, the identifying code processor 502, and/or a communications module 504 may be configured to cause a first apparatus condition resolution data to be transmitted to a printer so as to resolve the first apparatus condition that caused the printer to display the first dynamic identifier code at Step 1730. For example, the code reading device, such as the one illustrated in FIG. 5, may include a communications module 504 configured to transmit a first apparatus condition resolution data to a printer device. In one instance, the printer device may be experiencing a first apparatus condition, such as a printhead temperature operating outside of a desired temperature range for a particular printer media. Accordingly, any one of the processor 500, the identifying code processor 502, and/or a communications module 504 may be configured to cause a first apparatus condition resolution data, such as instructions for operating the printer at a correct printhead temperature, to be transmitted to the printer, so as to resolve the first apparatus condition.

According to some embodiments, the code acquisition module 510 may capture a second image associated with a second dynamic identifier code displayed by the input/output module 404 of the printer, such as the one illustrated in FIG. 4, at Step 1732. At Step 1734, a processor 500 and/or an identifying code processor 502 may be configured to extract a second apparatus condition data from the second image data corresponding to the second image, which is associated with the second dynamic identifier code representative of the second apparatus condition. According to some embodiments, a processor 500 and/or an identifying code processor 502 of a code reading device may be configured to retrieve a second user message from a memory 508 of the code reading device in response to at least one of extracting the second apparatus condition data and a user identity data, which may also be stored in memory 508, at Step 1736. At Step 1738, the processor 500 and/or an identifying code processor 502 of a code reading device may provide the second user message to an input/output module 506, such as a display. Additionally and/or alternatively, any one of the processor 500, the identifying code processor 502, and/or a communications module 504 may be configured to cause a second apparatus condition resolution data to be transmitted to a printer so as to resolve the second apparatus condition that caused the printer to display the second dynamic identifier code at Step 1740. The process then ends at Step 1742.

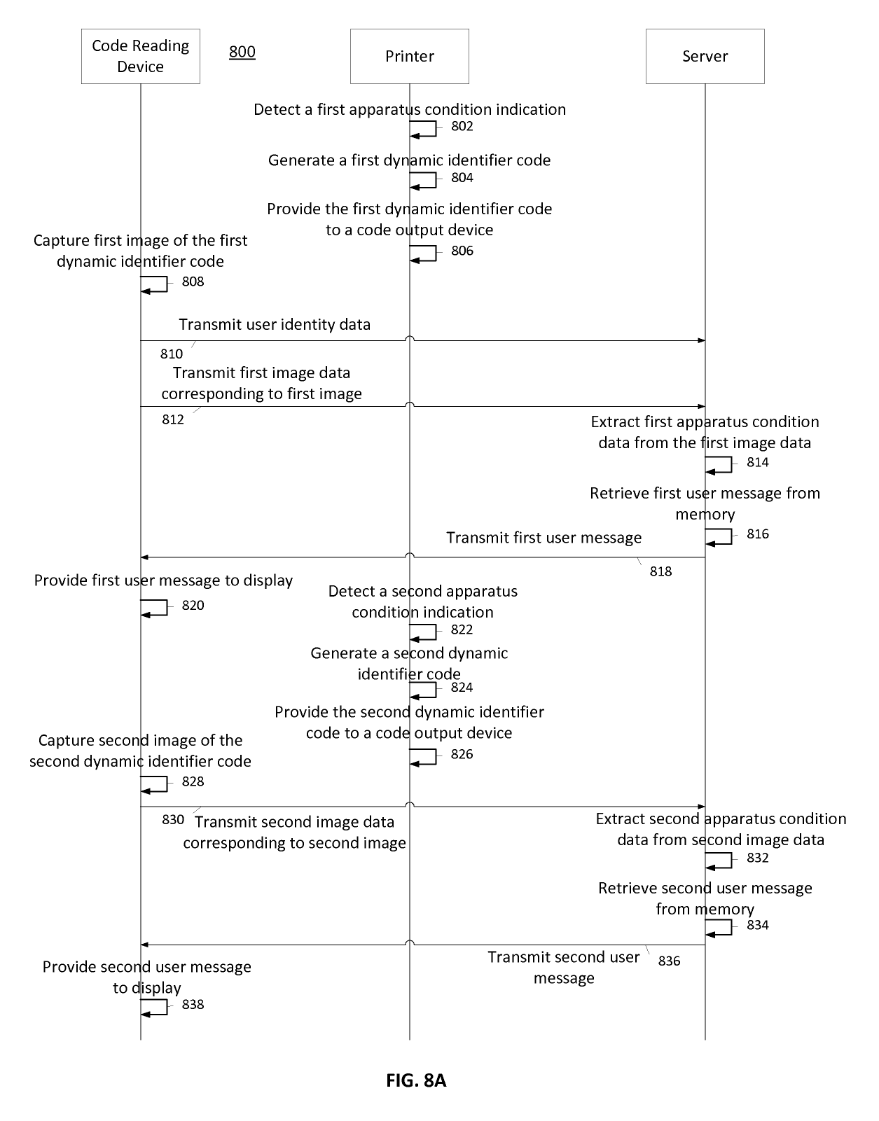

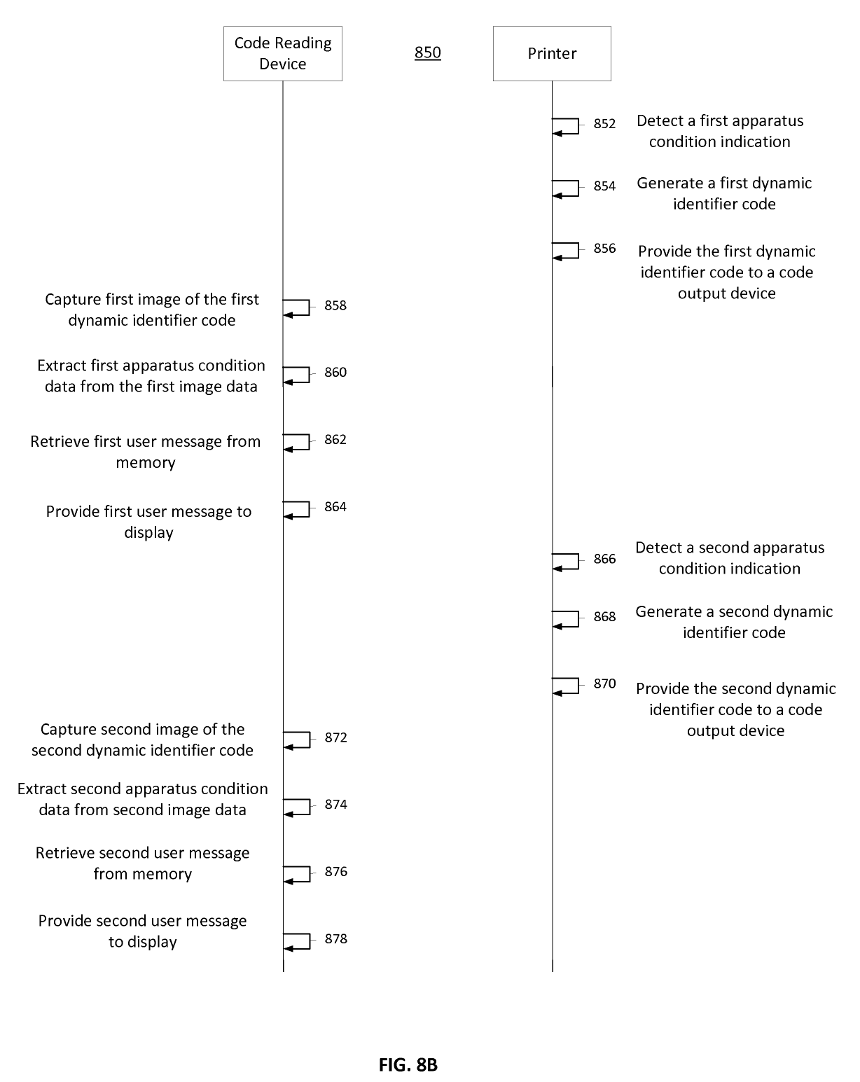

FIG. 8A illustrates a flowchart of a method 800 for providing enhanced printer functionality according to one embodiment of the present invention. At Step 802, a processor 400 of a printer, such as one illustrated in FIG. 4, may detect a first apparatus condition indication. For example, a printer may include a number of sensors configured to communicate with the processor 400. According to some embodiments, the processor may be configured to communicate with at least one of a plurality of printhead sensors, printer motor sensors, printer housing sensors, printer media supply sensors, and/or the like. As such, the sensors may be configured to provide the processor 400 with data corresponding to various printer conditions and/or events. At Step 804, the processor 400 of the printer may be configured to generate a first dynamic identifier code representative of a first apparatus condition in response to detecting the first apparatus condition indication. According to some embodiments, an identifying code processor 412, may be configured to generate the first dynamic identifier code at Step 804. In some embodiments, the processor and/or identifying code processor may be configured to provide the first dynamic identifier code to a code output device, such as the identifying code emitter 414, as illustrated in FIG. 4, at Step 806. According to some embodiments, the code output device may be a display screen configured to display the first dynamic identifier code. In some embodiments, the code output device may be a printing mechanism (e.g., a printer controller, printhead, motor-driven platen roller, media handling mechanism, etc.) configured to print the dynamic identifier code onto print media so as to be captured by a code reading device.

At Step 808, a code acquisition module 510 of a code reading device, such as the one illustrated in FIG. 5, may be configured to capture a first image associated with a first dynamic identifier code provided by the code output device of the printer. At Step 810, a processor 500 and/or a communications module 504 of a code reading device may cause a user identity data, which may be stored in a memory 508, to be transmitted to a server. According to some embodiments, a processor 500 and/or a communications module 504 of a code reading device may cause a first image data corresponding to the first image captured by the code acquisition module to be transmitted to the server at Step 812.

At Step 814, a processor 600 and/or an identifying code processor 602 of the server may be configured to extract first apparatus condition data from the first image data corresponding to the first image associated with the first dynamic identifier code representative of the first apparatus condition at Step 814. In some embodiments, the processor 600 and/or an identifying code processor 602 may be configured to retrieve a first user message stored in a memory 608 in response to, in part, extracting the first apparatus condition data and/or receiving the user identity data from the code reading device, at Step 816. Accordingly, the processor, the identifying code processor, and/or the communications module of the printer may be configured to cause the first user message to be transmitted to a code reading device at Step 818. At Step 820, the processor 500 and/or an identifying code processor 502 of a code reading device may provide the first user image to an input/output module 506, such as a display, of the code reading device.

According to some embodiments, a processor 400 of the printer may be configured to detect a second apparatus condition at Step 822. The processor and/or the identifying code processor of the printer may be configured to then generate a second dynamic identifier code representative of a second apparatus condition in response to detecting the second apparatus condition indication, at Step 824. The processor and/or identifying code processor may be configured to provide the second dynamic identifier code to the code output device, such as an identifying code emitter, at Step 826.

In some embodiments, the code acquisition module 510 of the code reading device may capture a second image associated with a second dynamic identifier code displayed by the code output device of the printer, such as the one illustrated in FIG. 4, at Step 828. At Step 830, a processor 500 and/or a communications module 504 of a code reading device may cause a second image data corresponding to the second image captured by the code acquisition module to be transmitted to the server.

A processor 600 and/or an identifying code processor 602 may be configured to extract second apparatus condition data from a second image data corresponding to the second image associated with the second dynamic identifier code representative of the second apparatus condition at Step 832. In some embodiments, the processor 600 and/or an identifying code processor 602 may be configured to retrieve a second user message stored in a memory 608 in response to, in part, extracting the second apparatus condition data and/or receiving a user identity data at Step 834. Accordingly, the processor, the identifying code processor, and/or the communications module may be configured to cause the second user message to be transmitted to a code reading device at Step 836. At Step 838, the processor 500 and/or an identifying code processor 502 of the code reading device may then provide the second user message to an input/output module 506, such as a display.

FIG. 8B illustrates another method 850 for providing enhanced printer functionality according to some embodiments of the present invention. At Step 852, a processor 400 of a printer, such as one illustrated in FIG. 4, may detect a first apparatus condition indication. For example, a printer may include a number of sensors configured to communicate with the processor 400. According to some embodiments, the processor may be configured to communicate with at least one of a plurality of printhead sensors, printer motor sensors, printer housing sensors, printer media supply sensors, and/or the like. As such, the sensors may be configured to provide the processor 400 with data corresponding to various printer conditions and/or events. At Step 854, the processor 400 of the printer may be configured to generate a first dynamic identifier code representative of a first apparatus condition in response to detecting the first apparatus condition indication. According to some embodiments, an identifying code processor 412, may be configured to generate the first dynamic identifier code at Step 854. In some embodiments, the processor and/or identifying code processor may be configured to provide the first dynamic identifier code to a code output device, such as the identifying code emitter 414, as illustrated in FIG. 4, at Step 856. According to some embodiments, the code output device may be a display screen configured to display the first dynamic identifier code. In some embodiments, the code output device may be a printing mechanism (e.g., a printer controller, printhead, motor-driven platen roller, media handling mechanism, etc.) configured to print the dynamic identifier code onto print media so as to be captured by a code reading device.

According to some embodiments, a code reading device, such as the one illustrated in FIG. 5, may include a code acquisition module 510 that captures a first image associated with a first dynamic identifier code displayed by a code output device, such as an identifying code emitter 414 of a printer, such as the one illustrated in FIG. 4, at Step 858. At Step 860, a processor 500 and/or an identifying code processor 502 may be configured to extract a first apparatus condition data from the first image data corresponding to the first image, which is associated with the first dynamic identifier code representative of the first apparatus condition. According to some embodiments, a processor 500 and/or an identifying code processor 502 of a code reading device may be configured to retrieve a first user message from a memory 508 of the code reading device in response to at least one of extracting the first apparatus condition data and a user identity data, which may also be stored in memory 508, at Step 862. At Step 864, the processor 500 and/or an identifying code processor 502 of a code reading device may provide the first user message to an input/output module 506, such as a display.

According to some embodiments, a processor 400 of the printer may be configured to detect a second apparatus condition at Step 866. The processor and/or the identifying code processor of the printer may be configured to then generate a second dynamic identifier code representative of a second apparatus condition in response to detecting the second apparatus condition indication, at Step 868. The processor and/or identifying code processor may be configured to provide the second dynamic identifier code to the code output device, such as an identifying code emitter, at Step 870.

According to some embodiments, the code acquisition module 510 may then capture a second image associated with a second dynamic identifier code displayed by the code output device of the printer at Step 872. At Step 874, a processor 500 and/or an identifying code processor 502 may be configured to extract a second apparatus condition data from the second image data corresponding to the second image, which is associated with the second dynamic identifier code representative of the second apparatus condition. According to some embodiments, a processor 500 and/or an identifying code processor 502 of a code reading device may be configured to retrieve a second user message from a memory 508 of the code reading device in response to at least one of extracting the second apparatus condition data and a user identity data, which may also be stored in memory 508, at Step 876. At Step 878, the processor 500 and/or an identifying code processor 502 of a code reading device may provide the second user message to an input/output module 506, such as a display.

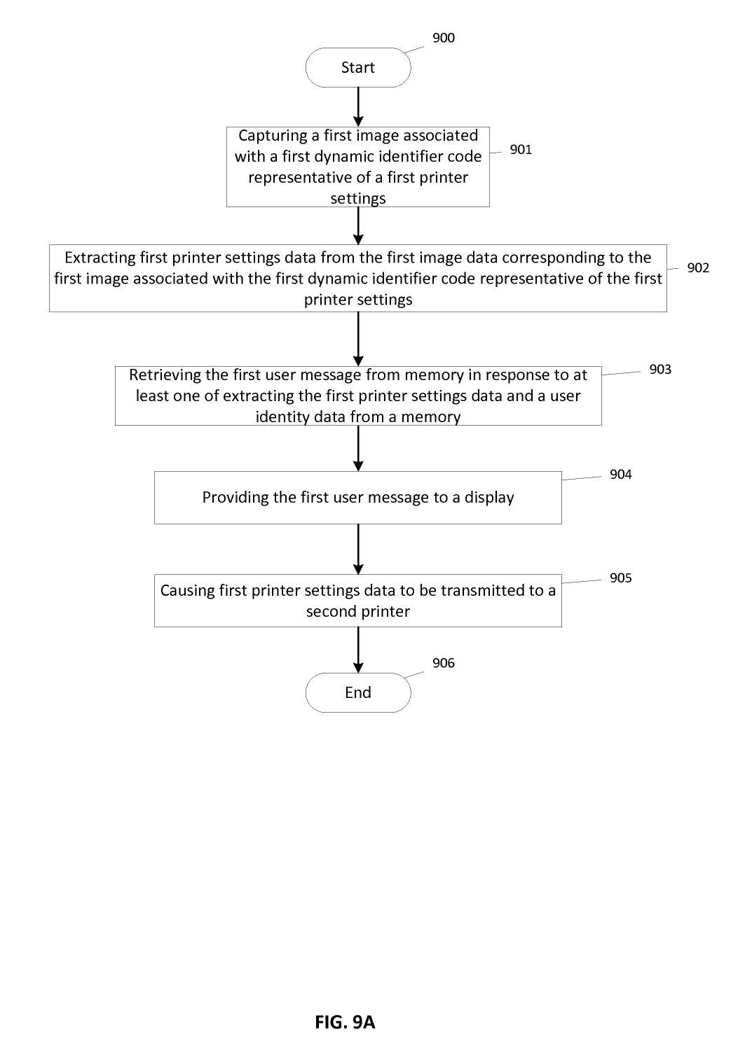

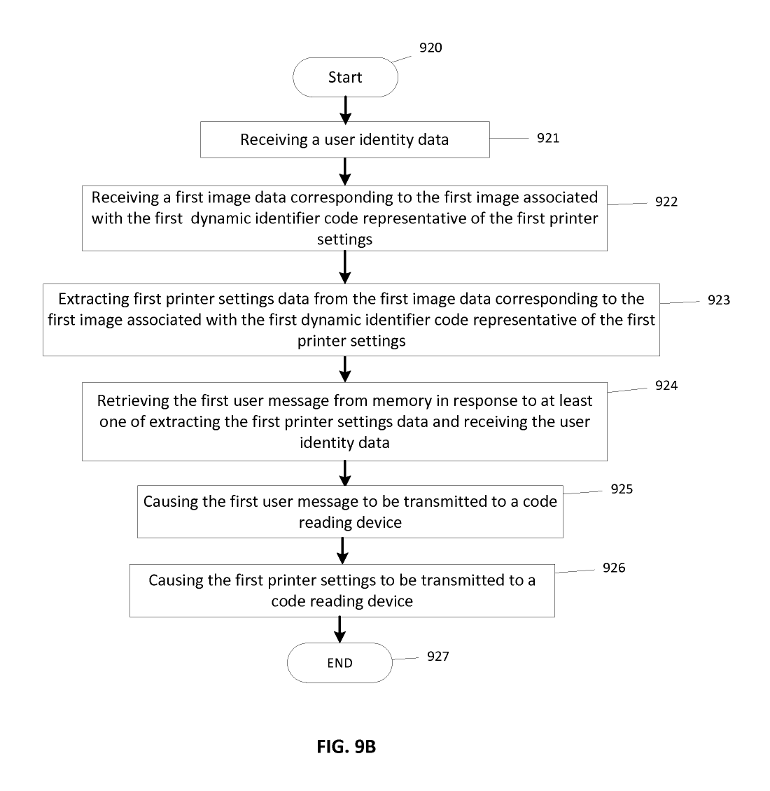

In another embodiment, the system may be configured to provide enhanced printer functionality with a code reading device as illustrated in FIG. 9A. According to one embodiment of the present invention, the system may be configured to provide for the setup of a second printer (i.e., a mirrored printer) with printer settings that are generally identical to a first printer. For instance, a user may provide an input to an input/output module 404 of a first printer 100 associated with a request for the first printer settings. A processor 400 and/or an identifying code processor may cause the first printer device to display a first dynamic identifier code associated with the settings of the first printer device.

Accordingly, the code acquisition module 510 of the code reading device 300 may then capture a first image associated with the first dynamic identifier code representative of the first printer settings at Step 901. At Step 902, the processor and/or identifying code processor may extract a first printer settings data from the first image associated with the first dynamic identifier code representative of the first printer settings. For example, the first printer settings data may be stored in a memory of the code reading device. In another embodiment, the code reading device may be configured to communicate with a server so as to receive the first printer settings data.

In some embodiments, the processor and/or identifying code processor of the code reading device may then retrieve a first user message from the memory in response to extracting the first printer settings data and/or a user identity data from a memory. For example, the first user message may be instructions to establish a wired or wireless communication connection with the second printer. In another embodiment, the first user message may detail the first printer settings so as to allow a user to manual input the first printer settings to the second printer. According to some embodiments, the processor and/or communications module 504 of the code reading device may be configured to cause a first printer settings data corresponding to the first printer settings to be transmitted to the second printer, at Step 905, such that the second printer may autonomously configure itself in a corresponding fashion to the first printer. The process may end at Step 906.

In another embodiment, the system may be configured to provide enhanced printer functionality with a code reading device as illustrated in FIG. 9B. According to one embodiment of the present invention, the system may be configured to provide for the setup of a second printer (i.e., a mirrored printer) with printer settings that are generally identical to the settings of the first printer. The process starts at Step 920. At Step 921, a communications module 604 of the server illustrated in FIG. 6 may receive a user identity data from a code reading device. In some embodiments, the communications module 604 of the server may receive first image data corresponding to the first image associated with the first dynamic identifier code representative of a request to mirror the first printer settings for second printer from a code reading device, such as one illustrated in FIG. 5 at Step 922. A processor 600 and/or an identifying code processor 602 may be configured to extract first printer settings data from the first image data corresponding to the first image associated with the first dynamic identifier code representative of the mirroring request of the first printer settings at Step 923. In some embodiments, the processor 600 and/or an identifying code processor 602 may be configured to retrieve a first user message stored in a memory 608 in response to, in part, extracting the first printer settings data and receiving the user identity data at Step 924. Accordingly, the processor, the identifying code processor, and/or the communications module may be configured to cause the first user message to be transmitted to a code reading device at Step 925. For example, the first user message may be a confirmation message that the server has received the request to mirror the first printer settings on the second printer. In another embodiment, the first user message may be instructions for mirroring the first printer settings on the second printer. According to some embodiments, the processor, the identifying code processor, and/or the communications module may be configured to cause the first printer settings data to be transmitted to a code reading device such that the code reading device may communicate via a wired or wireless connection with the second printer for mirroring the first printer settings at Step 926. Additionally and/or alternatively, the processor, the identifying code processor, and/or the communications module may be configured to cause the first printer settings data to be transmitted to the second printer for mirroring the first printer settings. The process ends at Step 927.

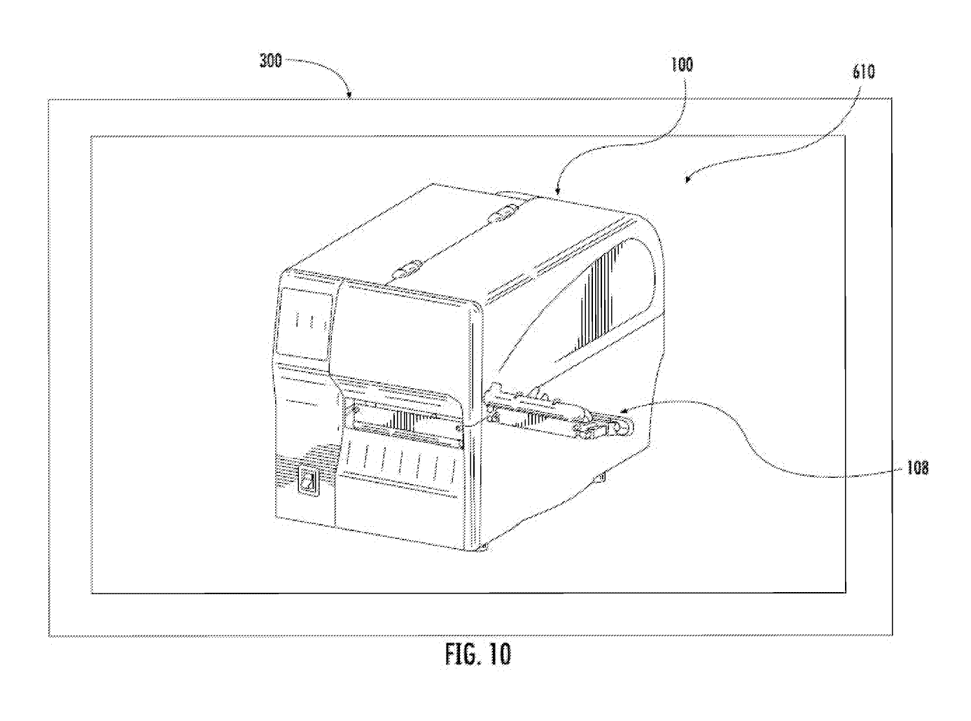

In yet another embodiment of the present invention, the code reading device 300 may be configured to capture a QR code displayed on a printer device and display an augmented reality (AR) illustration of the printer device 100 on a display screen 610 of the code reading device, as shown in FIG. 10. For example, should a component 108 of the printer device 100 experience a mechanical issue or other error, the system may be configured to provide the user with enhanced functionality, such as providing the user with the location of the defective component 108 within the printer 100. Additionally, or alternatively, the code reading device 300 may be configured to display instructions on how to replace the defective component 108 on the display screen 610.

In some embodiments, the instructions displayed to the user may be enhanced by augmented reality (AR) technologies. AR technology functionality may be provided by computer program products executed by the code reading device, the network/server or some combination thereof, such as the AR software development kit (“AR SDK”) provided by Qualcomm® and other similar technologies.

In one example, the code reading device may include an input/output module 506, such as a video camera configured to capture a live video feed and display such video data on a display screen 610 of the code reading device. After capturing the QR code displayed on the printer device 100 with the code acquisition module 510, the QR code indicating that the printer device includes a defective component 108, the code reading device 300 may be configured to transmit a first image data corresponding to the QR code to a server via a communications module 504. Accordingly, the communications module 504 and/or the processor 500 may be configured to receive data corresponding to the indication of the defective component 108.

In some embodiments, the code reading device 300 may be configured to capture the live video feed and display a live video picture of the printer device 100 on the display screen 610. Concurrently, the processor of the code reading device may be configured to cause an indicia to be overlaid onto the live video images, such as a highlighted wireframe of the defective component, in response to receiving data corresponding to the indication of the defective component, so as to better inform the user as to the location and repair procedure for the defective component 108.

In another example embodiment, the code reading device may be configured to display a video illustrating replacement of the motherboard for the printer that is overlaid onto the live video images of the printer device. Further, the processor of the code reading device may be configured to provide an augmented reality view that may illustrate particular buttons to push on the printer device by highlighting or otherwise indicating the specific buttons, an augmented reality view that may illustrate how and where to move certain parts of the printer device, and/or instructions, illustrations, or videos in a sequence for such steps or actions. For instance, an input/output module, such as a video camera, and the processor of the code reading device may be configured to identify when a user has moved a particular component of the printer device so that a subsequent repair step and/or instructions may then be displayed on the display 610 using the AR technology.

In another embodiment, the code reading device may be configured to identify the printer by capturing video data of the printer device without the printer device displaying a QR code. For example, an input/output module of the code reading device may be configured to capture a video recording of the printer. Further, the communications module of the code reading device may be configured to transmit a video recording data to a server, which may include a processor configured to identify the printer based at least upon the size, shape, and/or other visual characteristics. In addition, the processor of the server may be configured to transmit data associated with the printer identity via a communications module to the code reading device. As such, a user may be able to identify the printer when no power is available for the printer device.

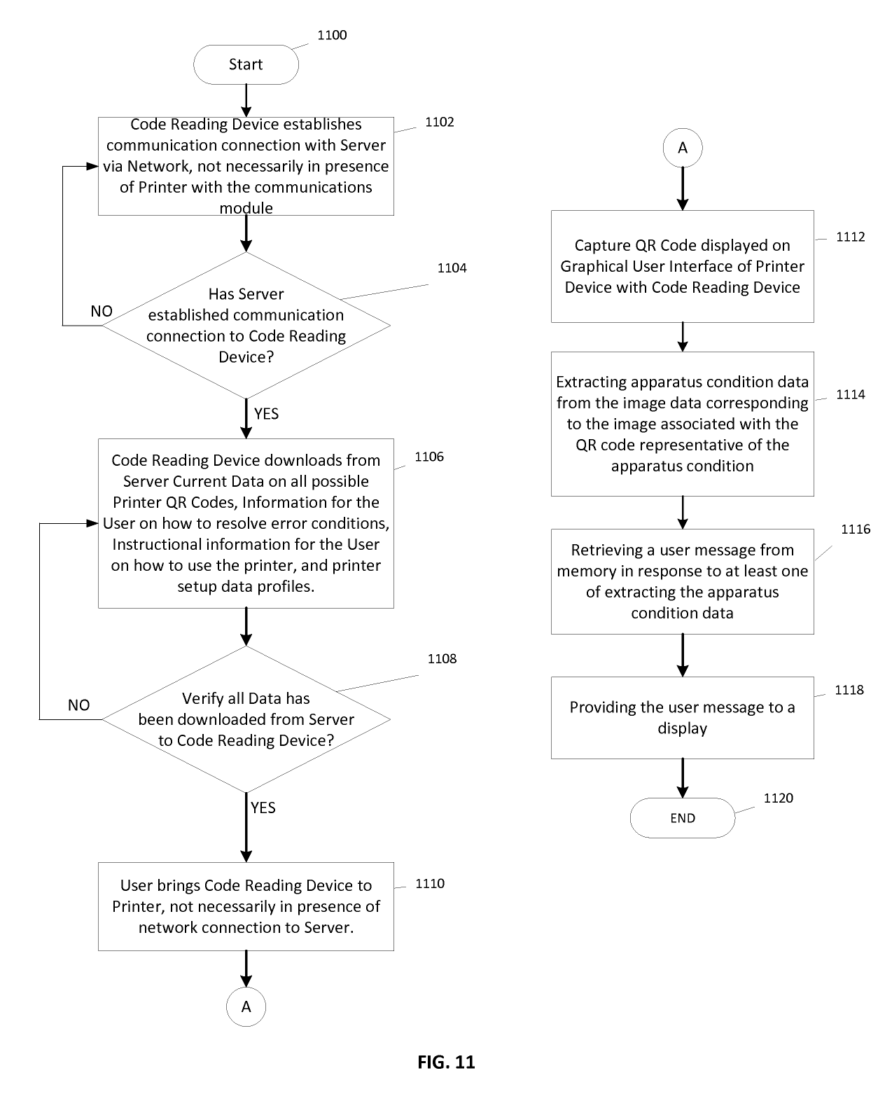

In yet another embodiment, FIG. 11 illustrates another example embodiment method of providing enhanced printer functionality with a code reading device. The process begins at Step 1100. The communications module of a code reading device establishes a communication connection with a server via a communication network even though the printer may not necessarily be connected with the communication network at Step 1102. At Step 1104, the processor of the server and/or the processor of the code reading device may verify that a connection has been established. If the connection has been established, the code reading device may then download current data on all possible printer dynamic identifier codes, information or data for resolving those conditions causing the display of the dynamic identifier codes, and/or instructional information for the user to setup a printer device via the communications module of the code reading device at Step 1106. The processor of the code reading device may then check to verify that all relevant data has been downloaded from the server to the code reading device at Step 1108. In some embodiments, the relevant data may be stored in a memory of the code reading device.

At Step 1110, a user may physically bring the code reading device to the printer device that is still not necessarily connected to the server via a network connection. The user may then capture the QR code that is displayed by the printer device with the code reading device at Step 1112 with the code acquisition module of the code reading device. At Step 1114, the processor and/or identifying code processor of the code reading device may extract an apparatus condition data from image data corresponding to the QR code that is representative of the printer device condition. The processor then retrieves a user message, information, instructions and/or the like from memory in response to at least one of extracting the apparatus condition data corresponding to the printer condition and/or resolving the printer condition that caused the display of the QR code at Step 1116. At Step 1118, the processor of the code reading device may cause the user message to be provided to an input/output module, such as a display, such that the instructions to resolve the condition that prompted the printer device to display the QR code are provided to the user. The process ends at Step 1120.

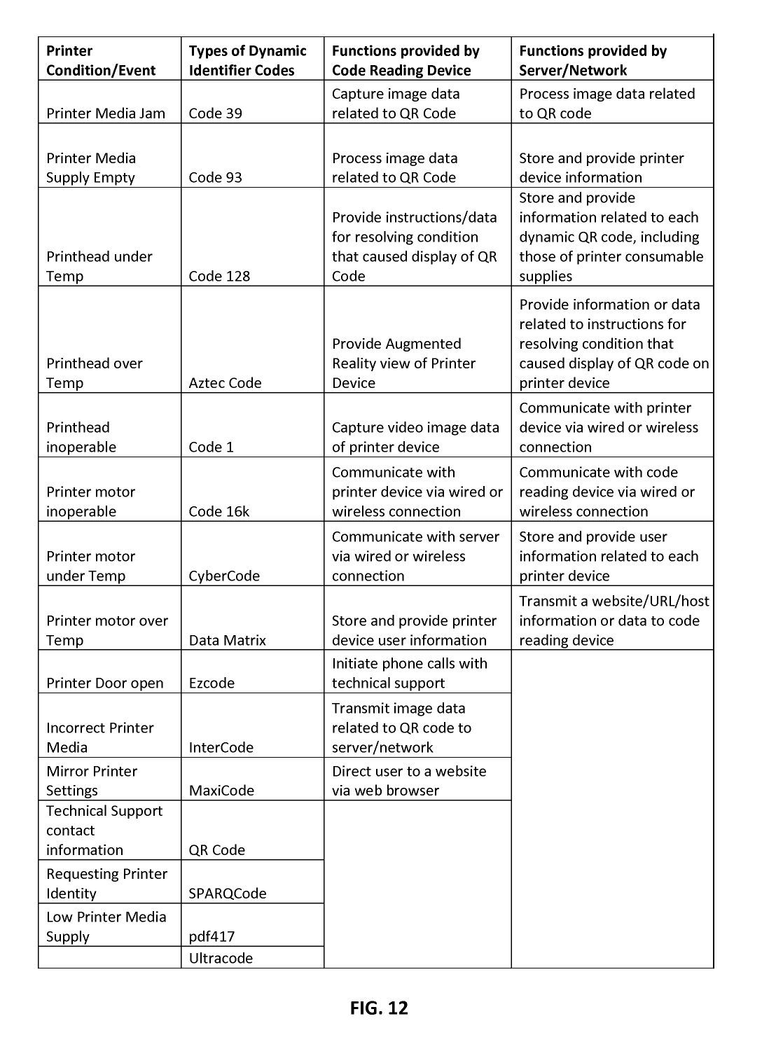

FIG. 12 depicts a table outlining example embodiments of particular printer conditions for displaying QR codes. FIG. 12 is not meant to be exhaustive of all conditions or events, but is merely provided for illustrative purposes of exemplary embodiments. Further, FIG. 12 includes a list of types of dynamic identifier codes and particular functions that the code reading device and the server may be capable of performing in some embodiments. Again, this listing is not meant to limit the embodiments of the invention to a specific embodiment disclosed, but are merely descriptive to illustrate the varying functionalities of components of the system for providing enhanced printer functionality.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed:

1. A method comprising:
capturing a first image associated with a first dynamic identifier code representative of a first apparatus condition;
extracting a first apparatus condition data from the first image associated with the first dynamic identifier code;
retrieving data associated with a first apparatus condition solution in response to extracting the first apparatus condition data;
retrieving a first user message from a memory in response to extracting the first apparatus condition data based on a user identity; and
providing the first user message to a display.

2. The method of claim 1 further comprising:
capturing a second image associated with a second dynamic identifier code representative of a second apparatus condition, wherein the second dynamic identifier code is different than the first dynamic identifier code;
extracting the second apparatus condition data from the second image associated with the second dynamic identifier code;
retrieving data associated with a second apparatus condition solution in response to extracting the second apparatus condition data.
retrieving a second user message from a memory in response to extracting the second apparatus condition data based on the user identity; and
providing the second user message to a display.

3. The method of claim 1 further comprising:
causing an apparatus with a first apparatus condition to resolve the first apparatus condition by at least causing the data associated with the first apparatus condition solution to be transmitted to the apparatus.

4. The method of claim 1 further comprising:
capturing video data of the apparatus; and
causing the video data to be displayed, wherein the first user message comprises an indicia overlaid onto the video data.

5. The method of claim 1, wherein the user identity data is indicative of a user skill level; and
wherein the first user message is further based on the user skill level.

6. The method of claim 1, wherein at least one of the first dynamic identifier code and the second dynamic identifier code is a linear symbology code.

7. The method of claim 1, wherein at least one of the first dynamic identifier code and the second dynamic identifier code is a two dimensional symbology code.

8. An apparatus comprising at least one processor and at least one memory including computer program code, the at least one memory and computer program code configured to, with the processor, cause the apparatus to at least:
capture a first image associated with a first dynamic identifier code representative of a first apparatus condition;
extract a first apparatus condition data from the first image associated with the first dynamic identifier code;
retrieve data associated with a first apparatus condition solution in response to extract the first apparatus condition data;
retrieve a first user message from a memory in response to extracting the first apparatus condition data based on a user identity; and
provide the first user message to a display.

9. The apparatus of claim 8, wherein the at least one memory and the computer program code are further configured to:
capture a second image associated with a second dynamic identifier code representative of a second apparatus condition, wherein the second dynamic identifier code is different than the first dynamic identifier code;
extract the second apparatus condition data from the second image associated with the second dynamic identifier code;
retrieve data associated with a second apparatus condition solution in response to extracting the second apparatus condition data.
retrieve a second user message from a memory in response to extracting the second apparatus condition data based on the user identity; and
provide the second user message to a display.

10. The apparatus of claim 8, wherein the at least one memory and the computer program code are further configured to:
cause an apparatus with a first apparatus condition to resolve the first apparatus condition by at least causing the data associated with the first apparatus condition solution to be transmitted to the apparatus.

11. The apparatus of claim 8, wherein the at least one memory and the computer program code are further configured to:
capture video data of the apparatus; and
cause the video data to be displayed, wherein the first user message comprises an indicia overlaid onto the video data.

12. The apparatus of claim 8, wherein the user identity data is indicative of a user skill level; and
wherein the first user message is further based on the user skill level.

13. The apparatus of claim 8, wherein at least one of the first dynamic identifier code and the second dynamic identifier code is a linear symbology code.

14. The apparatus of claim 8, wherein at least one of the first dynamic identifier code and the second dynamic identifier code is a two dimensional symbology code.

15. A computer program product comprising at least one non-transitory computer-readable storage medium having computer-executable program code portions stored therein, the computer-executable program code portions comprising program code instructions configured to:
capture a first image associated with a first dynamic identifier code representative of a first apparatus condition;
extract a first apparatus condition data from the first image associated with the first dynamic identifier code;
retrieve data associated with a first apparatus condition solution in response to extract the first apparatus condition data;
retrieve a first user message from a memory in response to extracting the first apparatus condition data based on a user identity; and
provide the first user message to a display.

16. The computer program product of claim 15, wherein the computer-executable program code portions further comprise program code instructions configured to:
capture a second image associated with a second dynamic identifier code representative of a second apparatus condition, wherein the second dynamic identifier code is different than the first dynamic identifier code;
extract the second apparatus condition data from the second image associated with the second dynamic identifier code;
retrieve data associated with a second apparatus condition solution in response to extracting the second apparatus condition data.
retrieve a second user message from a memory in response to extracting the second apparatus condition data based on the user identity; and
provide the second user message to a display.

17. The computer program product of claim 15, wherein the computer-executable program code portions further comprise program code instructions configured to:
cause an apparatus with a first apparatus condition to resolve the first apparatus condition by at least causing the data associated with the first apparatus condition solution to be transmitted to the apparatus.

18. The computer program product of claim 15, wherein the computer-executable program code portions further comprise program code instructions configured to:
capture video data of the apparatus; and
cause the video data to be displayed, wherein the first user message comprises an indicia overlaid onto the video data.

19. The computer program product of claim 15, wherein the user identity data is indicative of a user skill level; and
wherein the first user message is further based on the user skill level.

20. The computer program product of claim 15, wherein at least one of the first dynamic identifier code and the second dynamic identifier code is a two dimensional symbology code.
